(19) United States
(12) Patent Application Publication
(10) Pub. No.: US 2018/0185788 A1
(43) Pub. Date: Jul. 5, 2018

(54) SCR-CATALYZED SOOT FILTER WITH INTEGRATED LEAN NOx TRAP CATALYST FOR USE IN PASSIVE SELECTIVE CATALYTIC REDUCTION

(71) Applicant: BASF SE, Ludwigshafen (DE)

(72) Inventors: Gerd GRUBERT, Hannover (DE); Torsten NEUBAUER, Langenhagen (DE); Alfred PUNKE, Walle (DE)

(73) Assignee: BASF SE, Ludwigshafen (DE)

(21) Appl. No.: 15/736,511

(22) PCT Filed: Jun. 15, 2016
(86) PCT No.: PCT/EP2016/063750

§ 371 Date: Dec. 14, 2017

(30) Foreign Application Priority Data
Jun. 16, 2015 (EP) 15172347.5

(51) Int. Cl. B01D 53/94; B01J 23/42; B01J 23/44; B01J 23/46; B01J 35/02; B01J 35/04; B01J 37/00; B01J 37/02; B01J 37/04; B01J 37/08; F01N 3/023; F01N 3/20; F01N 3/28

(52) U.S. Cl. CPC B01D 53/9422; B01D 2257/404; B01J 23/42; B01J 23/44; B01J 23/464; B01J 35/023; B01J 35/04; B01J 37/0027; B01J 37/0246; B01J 37/0248; B01J 37/04; B01J 37/082; F01N 3/0231; F01N 3/2066; F01N 3/2892; B01D 2255/1021; B01D 2255/1023; B01D 2255/1025; B01D 2255/50; B01D 2255/908; B01D 2255/9155; B01D 53/9418

(57) ABSTRACT

Disclosed herein is a catalyzed soot filter (CSF) containing a porous wall flow substrate, a lean NOx trap (LNT) catalyst, and a catalyst for selective catalytic reduction (SCR). Also disclosed is a method of preparing the catalyzed soot filter, an emissions treatment system containing the catalyzed soot filter, and processes for treating exhaust gas emissions employing the catalyzed soot filter.

### TECHNICAL FIELD

The present invention relates to a catalyzed soot filter for the treatment of emissions from an internal combustion engine as well as to a method for its preparation. Furthermore, the present invention relates to a catalyzed soot filter as obtainable from the preparation method as well as to a process for the treatment of emissions from an internal combustion engine and to the use of a catalyzed soot filter according to the present invention.

### INTRODUCTION

As summarized in DiGiulio et al. in Catalysis Today 2014, 231, pp. 33-45, lean-burn engines are more fuel-efficient and produce less CO₂ than traditional, stoichiometric-burn engines. Full commercial implementation of lean-burn engines, however, requires the development of cost-effective catalysts capable of meeting current emissions regulations under lean-burn exhaust conditions, which still represents a major technical challenge. Since the late 1970s, three-way catalysts (TWC) have been employed for the simultaneous reduction of nitrogen oxides (NOx) and the oxidation of unburnt hydrocarbons and carbon monoxide (CO) present in the exhaust of stoichiometric-burn engines. However, these TWCs only sufficiently remediate pollutants if operated in a very narrow region near the stoichiometric combustion regime and exhibit very low NOx conversion if operated under the much higher O₂ concentrations encountered in lean-burn engine exhausts. Two existing solutions for the reduction of NOx in this case include the lean NOx trap (LNT) and NH₃-selective catalytic reduction (NH₃-SCR) catalysts. Both LNT and NH₃-SCR technologies however suffer from different but significant drawbacks. For example, LNT catalysts require high platinum group metal loadings, resulting in a significant cost per catalyst. NH₃-SCR catalysts are less expensive, but the dosing system required to deliver urea to the exhaust stream adds to the total cost of the exhaust system.

As reported in DiGiuglio et al. in Catalysis Today 2014, 231, pp. 33-45, a new technology referred to as the “passive-ammonia” or “urea-less” SCR approach has been recently demonstrated. As in the case of LNT systems, the passive-NH₃ approach is based on a periodic lean-rich cycling, but does not include an LNT catalyst. Instead, a TWC is used to generate NH₃ during periods of rich operation. The NH₃ thus generated is subsequently stored on a downstream, under-floor SCR catalyst. After a sufficient amount of NH₃ has been stored, the engine switches back to lean operation and the stored NH₃ is used to reduce NOx that slips un-reacted from the upstream TWC.

Apart from said technologies, efforts have been made to incorporate SCR catalyst technologies in soot filters for increasing the efficiency of exhaust gas treatment, in particular in application involved in the use of a diesel combustion engine. Thus, WO 2012/135871 A1 relates to multi-component filters for emissions control and in particular to a catalytic article comprising a wall flow filter having gas-permeable walls, a hydrolysis catalyst, and an optional soot oxidation catalyst, a selective catalytic reduction catalyst permeating the walls, an ammonia oxidation catalyst and an oxidation catalyst to oxidize CO and hydrocarbons. WO 2011/140251 A2, on the other hand, relates to integrated SCR and ammonia oxidation (AMOX) catalyst systems and in particular to a catalyst system including a first zone to abate nitrogen oxides by selective catalytic reduction, a second zone to oxidize ammonia, and a third zone to oxidize carbon monoxide and hydrocarbons. WO 20011/041769 A2 concerns four-way diesel catalysts for simultaneously remediating the carbon monoxide, nitrogen oxides, particulate matter, and gaseous hydrocarbons present in diesel engine exhaust streams.

In addition to these, multi-component systems have been further proposed in an attempt to provide a highly efficient exhaust gas treatment system. Thus, WO 2010/114873 A2 relates to an emissions treatment system with ammonia-generating and SCR catalysts such as an NOx storage reduction (NSR) catalyst or a lean NOx trap catalyst, and an SCR catalyst disposed downstream of the ammonia-generating catalyst.

EP 2428 659 A1, on the other hand, relates to a catalyst for the removal of NOx from diesel exhaust gas employing a flow through substrate onto which copper chabazite is provided in the downstream portion and barium oxide as well as platinum group metals are provided in the upstream portion. WO 2004/076829 A1 relates to an exhaust gas purification system for the selective catalytic reduction of nitrogen oxides in the lean exhaust gas of internal combustion engines involving the use of an NOx storage catalyst applied to a diesel particulate filter which is located upstream of an SCR catalyst. WO 2014/072067 A1 concerns a catalyst system for treating NOx- and particle-containing diesel exhaust gas involving the use of a nitrogen oxide storage catalyst containing a nitrogen oxide storage component and a precious metal which is located upstream of a catalyzed soot filter containing platinum group metals.

Nevertheless, there remains the need for the provision of a highly efficient emissions treatment system operating with the least possible number of components and low amounts of platinum group metals contained therein respectively yet affording a high efficiency relative to the reduction of both NOx and CO in exhaust gases while generating the lowest possible amount of excess ammonia in the course thereof.

### DETAILED DESCRIPTION

It was therefore the object of the present invention to provide a catalyzed soot filter which affords a high conversion of NOx and CO in exhaust gases in addition to the filtration of particulate matter relative to the amount of platinum group metals employed therein, and in particular with respect to the amount of platinum. Furthermore, it was the object of the present invention to provide a catalyzed soot filter which displays an excellent NOx conversion efficiency when employed in a passive SCR system, i.e. when used in combination with a component located upstream thereof which generates ammonia in situ for the conversion of NOx to nitrogen, yet without generating large amounts of excess ammonia in the course thereof. Thus, it has surprisingly been found that by employing a specific arrangement of a lean NOx trap catalyst and a catalyst for selective catalytic reduction in separate portions of a catalyzed soot filter, a high efficiency in NOx conversion and CO oxidation may be obtained using comparatively low amounts of platinum group metals in the lean NOx trap and in particular of platinum, palladium, and rhodium. Furthermore, it has quite unexpectedly been found that said particularly high efficiency in NOx conversion and CO oxidation may be achieved in a passive SCR system wherein ammonia is generated in situ upstream of the aforementioned catalyzed soot filter. In particular, it has been found that by using such an arrangement, it is also possible to maintain low levels of excess ammonia exiting the catalyzed soot filter.

Therefore, the invention relates to a catalyzed soot filter (CSF), wherein the CSF comprises a porous wall flow substrate, a lean NOx trap (LNT) catalyst, and a catalyst for selective catalytic reduction (SCR),

the wall flow substrate comprising an inlet end, an outlet end, a substrate axial length extending between the inlet end and the outlet end, and a plurality of channels defined by internal walls of the wall flow substrate, wherein the plurality of channels comprise inlet channels having an open inlet end and a closed outlet end, and outlet channels having a closed inlet end and an open outlet end,
wherein the LNT catalyst is provided on a portion of the surface of the inlet channel walls and on at least a portion of the surface of the pores within the channel walls underneath the surface of the channel walls coated with the LNT catalyst,
wherein the portion of the inlet channel walls coated with the LNT catalyst extends from the inlet end to x % of the substrate axial length with 0<x<100,
wherein the SCR catalyst is provided on a portion of the surface of the outlet channel walls and on at least a portion of the surface of the pores within the channel walls underneath the surface of the portions of the channel walls coated with the SCR catalyst,
wherein the portion of the outlet channel walls coated with the SCR catalyst extends from the outlet end to 100-x % of the substrate axial length.

As regards the extend to which the respective lean NOx trap catalyst and catalyst for selective catalytic reduction are provided on the respective inlet and outlet channels of the catalyzed soot filter according to the present invention, no particular restrictions apply such that in principle any portion of the inlet channel walls may be provided with the lean NOx trap catalyst extending from the inlet end to less than the entire substrate axial length, and accordingly any portion of the outlet channel walls may be provided with the catalyst for selective catalytic reduction extending from the outlet end to a length less than the entire substrate axial length, provided that the length of the palladium component provided from the inlet end and the length of the platinum component provided from the outlet end amount to the substrate axial length, i.e. 100% thereof. Thus, by way of example, x may range anywhere from 5 to 95, wherein it is preferred that x ranges from 15 to 85, more preferably from 25 to 75, more preferably from 35 to 65, and more preferably from 45 to 55. Alternatively, x may range from 5 to 65, wherein it is preferred that x ranges from 15 to 55, more preferably from 20 to 45, and more preferably from 25 to 35.

Regarding the porous wall flow substrate employed in the catalyzed soot filter, no particular restrictions apply as to its shape and dimensions nor with respect to the material with which it is made. According to the present invention, it is, however, preferred that the porous wall flow substrate is a honeycomb substrate with alternately plugged inlet and outlet ends such that each wall of the wall flow substrate respectively has a first surface which is a surface of an inlet channel and a second surface which is a surface of an outlet channel.

Same applies accordingly relative to the porosity of the walls of the wall flow substrate contained in the catalyzed soot filter such that said porosity may range anywhere from 40 to 85%, and preferably ranges from 45 to 80%, more preferably from 50 to 75%, more preferably from 55 to 70%, and more preferably in the range of from 60 to 65%. As regards the porosity as defined in the present application, it is preferred that said porosity is obtained via the mercury intrusion method, more preferably according to ISO 15901-1:2005.

As regards the average pore size of the walls of the wall flow substrate employed in the inventive catalyzed soot filter, again no particular restrictions apply such that wall flow substrates displaying any suitable average pore size may be employed. Thus, by way of example, the average pore size of the walls of the substrate may be in the range of from 5 to 50 μm, and preferably in the range of from 10 to 40 μm, more preferably from 13 to 35 μm, more preferably from 15 to 30 μm, more preferably from 17 to 25 μm, and more preferably from 18 to 22 μm. As for the porosity, it is noted that the average pore size of the walls of the substrate the uncoated wall flow substrate, i.e. prior to providing the SCR catalyst and the palladium and platinum components thereon. Furthermore, as for the porosity of the substrate, also the average pore size of the walls as defined in the present application preferably refers to the average pore size as determined by mercury porosimetry, and more preferably as obtained according to ISO 15901-1:2005.

As noted above, there is no particular restriction relative to the material of which the wall flow substrate consists such that by way of example it may comprise one or more selected from the group consisting of metals, metal oxides, and ceramic materials, wherein preferably the material of which the wall flow filter consists comprises one or more selected from the group consisting of cordierite, aluminum titanate, silicon carbide, mullite, and mixtures of two or more thereof, wherein more preferably the wall flow substrate is made of cordierite, aluminum titanate, or silicon carbide, and preferably of silicon carbide.

According to the present invention, the lean NOx trap catalyst and the catalyst for selective catalytic reduction are respectively provided on the surface of the channel walls of the wall flow substrate as well as on at least a portion of the surface of the pores within the channel walls underneath the surface of the channel walls coated therewith. Accordingly, the respective catalyst component penetrates the channel walls in the portions of the wall flow substrate on which it is respectively provided such that at least a portion of the pores contained within the walls of the wall flow substrate beneath the portions coated with the respective catalytic component are equally coated therewith. According to the present invention, there is no particular restriction as to the extend to which the pores located within the channel walls underneath the coated portions are themselves coated with the catalyst component such that the possibilities given by the present invention range from only coating the pores within the channel walls located in the immediate vicinity of the surface thereof to the coating of the surface of substantially all of the pores located within the channel walls underneath the surface coated with the respective catalyst component. Within the meaning of the present invention, a coating of the surface of the pores within the channel walls encompasses only a portion of the surface within a given pore being coated with the respective catalyst component. Thus, by way of example, as regards the lean NOx trap catalyst, it may be provided on at least a portion of the surface of the pores within the channel walls underneath the surface of the channel walls coated with the lean NOx trap catalyst extending from the surface of the inlet channel walls coated with the lean NOx trap catalyst to a depth of 10% or more of the thickness of the walls of the uncoated substrate. According to the present invention, however, it is preferred that the lean NOx trap catalyst is provided on at least a portion of the surface of the pores within the channel walls underneath the surface of the channel walls coated with the lean NOx trap catalyst extending from the surface of the inlet channel walls coated with the lean NOx trap catalyst to a depth of 15% or more of the thickness of the walls of the uncoated substrate, and more preferably to a depth of 20% or more, more preferably of 35% or more, more preferably of 40% or more, more preferably of 50% or more, and more preferably to a depth of 70% or more of the thickness of the walls of the uncoated substrate.

Same applies accordingly with respect to the SCR catalyst such that according to the present invention the SCR catalyst may be provided by way of example on at least a portion of the surface of the pores within the channel walls underneath the surface of the portions of the channel walls coated with the SCR catalyst extending from the surface of the outlet channel walls coated with the SCR catalyst to a depth of 10% or more of the thickness of the walls of the uncoated substrate, wherein preferably the SCR catalyst is provided on at least a portion of the surface of the pores within the channel walls underneath the surface of the portions of the channel walls underneath the surface of the portions of the channel walls coated with the SCR catalyst extending from the surface to a depth of 15% or more, more preferably to a depth of 20% or more, more preferably of 35% or more, more preferably of 40% or more, more preferably of 50% or more, and more preferably to a depth of 70% or more of the thickness of the walls of the uncoated substrate.

As regards the method according to which the respective penetration of the lean NOx trap catalyst and of the catalyst for selective catalytic reduction within the channel walls according to any of the particular and preferred embodiments of the present invention may be determined, no particular restrictions apply such that any conceivable method may be employed to this end. It is, however, preferred according to the present invention that the depth to which the lean NOx trap catalyst and the catalyst for selective catalytic reduction respectively extend within the channel walls is determined via scanning electron microscopy (SEM) of a cross-section of the coated substrate.

As regards the SCR catalyst comprised in the catalyzed soot filter according to the present invention, no particular restriction applies relative to the materials contained therein provided that the selective catalytic reduction of NOx to N₂ via reduction with ammonia may be catalyzed by said material. Thus, any suitable SCR-active material may be comprised in the SCR catalyst. According to the present invention it is however preferred that the SCR catalyst comprises one or more zeolites, and more preferably one or more zeolites having a structure type selected from the group consisting of BEA, CHA, FAU, FER, HEU, LEV, MEI, MEL, MFI, MOR, including mixed structures and combinations of two or more thereof, more preferably from the group consisting of BEA, CHA, LEV, MFI, including mixed structures and combinations of two or more thereof, wherein more preferably the one or more zeolites are of the BEA and/or CHA structure type, preferably of the CHA structure type, wherein more preferably the one or more zeolites comprise chabazite, the one or more zeolites preferably being chabazite.

According to the present invention it is yet further preferred that the one or more zeolites comprised by the SCR catalyst according to any of the particular and preferred embodiments of the present invention contain one or more transition metals. As regards the one or more transition metals preferably contained in the one or more zeolites preferably comprised by the SCR catalyst, no particular restrictions apply such that in principle any conceivable transition metal may be contained therein. It is, however, preferred according to the present invention that the one or more zeolites contain one or more transition metals selected from the group consisting of Pt, Pd, Rh, Cu, Co, Cr, Ni, Fe, V, Nb, and combinations of two or more thereof, more preferably one or more transition metals selected from the group consisting of Cu, Co, Cr, Ni, Fe, and combinations of two or more thereof, wherein more preferably the one or more zeolites contain Cu and/or Fe, preferably Cu.

Regarding the particular and preferred embodiments of the present invention wherein the one or more zeolites preferably comprised in the SCR catalyst of the catalyzed soot filter contain one or more transition metals, there is no particular restriction as to the state in which the respective transition metals are contained in the one or more zeolites and in particular the method according to which the one or more transition metals are introduced into the zeolite. It is however preferred according to the present invention that the one or more transition metals contained in the one or more zeolites preferably comprised in the SCR catalyst have been introduced into the zeolite by ion-exchange and/or by impregnation, wherein it is particularly preferred that the one or more transition metals have been introduced therein by ion-exchange.

As regards the amount in which the one or more preferred zeolites optionally containing one or more transition metals are contained in the catalyzed soot filter of the present invention, no particular restriction applies such that these may be contained therein in any suitable amount. Thus, by way of example, the one or more zeolites optionally containing one or more transition metals may be contained in the catalyzed soot filter as SCR catalyst in an amount ranging anywhere from 0.05 to 6 g/in³ calculated as the total weight of the one or more zeolites, optionally containing one or more transition metals, in the calcined state and based on the volume of the catalyzed soot filter measured from the outlet end up to 100-x % of the substrate axial length, and more preferably from 0.1 to 5 g/in³, more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.

Within the meaning of the present invention, the term “calcined state” preferably refers to the state of the one or more zeolites optionally containing one or more transition metals after calcining thereof in air at 450° C. for one hour.

Concerning the size of the particles of the SCR catalyst which is provided on the wall flow substrate in the catalyzed soot filter, no particular restrictions apply provided that the particles may be provided not only on the surface of the inlet channel walls but also on at least a portion of the surface of the pores within the channel walls underneath the surface of the channel walls. For achieving this, it is preferred that the average particle size D90 of the SCR catalyst is 25% or less of the average pore size of the walls of the substrate. Thus, by way of example, the average particle size D90 of the SCR catalyst may range anywhere from 0.5 to 20 μm, more preferably the average particle size D90 ranges from 1 to 15 μm, more preferably of from 3 to 10 μm, more preferably of from 4 to 8 μm, and more preferably of from 5 to 7 μm.

According to the present invention, the average particle size D90 refers to the average particle size calculated from the particle size distribution as preferably obtained from laser diffraction and more preferably as obtained according to ISO 13320:2009.

According to the present invention, there is no particular restriction as to the amounts of the lean NOx trap catalyst which may be provided on the catalyzed soot filter. Thus, the lean NOx trap catalyst may be contained in the catalyzed soot filter and in particular in the portion of the catalyzed soot filter coated with the lean NOx trap catalyst extending from the inlet end to x % of the substrate axial length in an amount ranging anywhere from 0.05 to 6 g/in³ based on the volume of the catalyzed soot filter measured from the inlet end up to x % of the substrate axial length. According to the present invention it is however preferred that the lean NOx trap catalyst is contained in the portion of the catalyzed soot filter coated with the lean NOx trap catalyst extending from the inlet end to x % of the substrate axial length in an amount in the range of from 0.1 to 5 g/in³, and more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.

There is no particular restriction according to the present invention relative to the components which may be contained in the lean NOx trap catalyst, provided that these are suitable for trapping NOx contained in exhaust gas as NO and/or NO₂ and preferably as NO, or do not impede the storage of NOx by other components contained in the lean NOx trap catalyst. According to the present invention it is preferred that the lean NOx trap catalyst comprises one or more alkaline earth metals and preferably one or more alkaline earth metals selected from the group consisting of Mg, Ca, Ba, Sr, and combinations of two or more thereof. According to the present invention it is yet further preferred that the lean NOx trap catalyst comprises one or more alkaline earth metals selected from the group consisting of Mg, Ca, Ba, and combinations of two or more thereof, wherein even more preferably Mg and/or Ba, and preferably Ba is contained as the alkaline earth metal in the lean NOx trap catalyst according to particular and preferred embodiments of the present invention. As regards the form in which the alkaline earth metals may be contained in the lean NOx trap catalyst, no particular restrictions apply, wherein preferably the one or more alkaline earth metals according to the particular and preferred embodiments of the present invention are contained in the oxide form in the lean NOx trap catalyst.

According to the present invention, there is no particular restriction as to the amounts of the one or more alkaline earth metals which are preferably contained in the lean NOx trap catalyst and accordingly contained in the portion of the catalyzed soot filter coated with the lean NOx trap catalyst extending from the inlet end to x % of the substrate axial length. Thus, the one or more alkaline earth metals according to any of the particular and preferred embodiments of the present invention may be contained in the portion of the catalyzed soot filter coated with the lean NOx trap catalyst extending from the inlet end to x % of the substrate axial length in an amount ranging anywhere from 0.01 to 2 g/in³ of the one or more alkaline earth metals calculated as the oxide and based on the volume of the catalyzed soot filter measured from the inlet end up to x % of the substrate axial length. According to the present invention it is however preferred that the one or more alkaline earth metals are contained in the portion of the catalyzed soot filter coated with the lean NOx trap catalyst extending from the inlet end to x % of the substrate axial length in an amount in the range of from 0.05 to 1 g/in³, and more preferably from 0.1 to 0.8 g/in³, more preferably from 0.15 to 0.6 g/in³, more preferably from 0.2 to 0.45 g/in³, more preferably from 0.25 to 0.38 g/in³, more preferably from 0.28 to 0.35 g/in³, more preferably from 0.30 to 0.33 g/in³, more preferably from 0.31 to 0.32 g/in³. Within the meaning of the present invention, the oxides of the alkaline earth metals according to the particular and preferred embodiments are MgO, CaO, BaO, and SrO.

According to the present invention it is preferred that the lean NOx trap catalyst comprises one or more oxygen storage components and preferably one or more oxygen storage components selected from the group consisting of zirconia, ceria, lanthana, praseodymia, neodymia, and mixtures thereof. According to the present invention it is yet further preferred that the lean NOx trap catalyst comprises one or more oxygen storage components selected from the group consisting of ceria, lanthana, praseodymia, neodymia, and mixtures thereof, wherein more preferably the oxygen storage component comprises ceria and/or praseodymia. According to the present invention it is particularly preferred that the oxygen storage component comprised in the lean NOx trap catalyst comprises ceria, wherein more preferably the oxygen storage component comprised in the lean NOx trap catalyst is ceria and/or praseodymia. According to the present invention it is particularly preferred that the oxygen storage component comprised in the lean NOx trap catalyst is ceria. As defined in the present application, zirconia, ceria, lanthana, praseodymia, neodymia preferably refer to the compounds ZrO₂, CeO₂, La₂O₃, Pr₆O₁₁, and Nd₂O₃, respectively.

According to the present invention, there is no particular restriction as to the amounts of the one or more oxygen storage components which are preferably contained in the lean NOx trap catalyst and accordingly contained in the portion of the catalyzed soot filter coated with the lean NOx trap catalyst extending from the inlet end to x % of the substrate axial length, provided that said one or more components are suited for reversibly storing oxygen from oxygen gas under given conditions. Thus, the one or more oxygen storage components according to any of the particular and preferred embodiments of the present invention may be contained in the portion of the catalyzed soot filter coated with the lean NOx trap catalyst extending from the inlet end to x % of the substrate axial length in an amount ranging anywhere from 0.01 to 3 Win′ based on the volume of the catalyzed soot filter measured from the inlet end up to x % of the substrate axial length. According to the present invention it is however preferred that the one or more oxygen storage components are contained in the portion of the catalyzed soot filter coated with the lean NOx trap catalyst extending from the inlet end to x % of the substrate axial length in an amount in the range of from 0.05 to 2 g/in³, and more preferably from 0.1 to 1.5 g/in³, more preferably from 0.2 to 1.2 g/in³, more preferably from 0.3 to 1 g/in³, more preferably from 0.4 to 0.8 g/in³, more preferably from 0.45 to 0.7 g/in³, more preferably from 0.5 to 0.6 g/in³, more preferably from 0.53 to 0.55 g/in³.

Same applies accordingly relative to the amount of the SCR catalyst such that it may for example be contained in the catalyzed soot filter and in particular in the portion of the catalyzed soot filter coated with the SCR catalyst extending from the outlet end to 100-x % of the substrate axial length in an amount ranging anywhere from 0.05 to 6 g/in³ based on the volume of the catalyzed soot filter measured from the outlet end up to 100-x % of the substrate axial length. According to the present invention it is however preferred that the SCR catalyst is contained in the portion of the catalyzed soot filter coated with the SCR catalyst extending from the outlet end to 100-x % of the substrate axial length in an amount in the range of from 0.1 to 5 g/in³, and more preferably in an amount in the range of from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³. For sake of completeness, it is noted that within the meaning of the present application, the amounts of materials in the catalyzed soot filter and other catalyzed monoliths expressed in g/in³ or g/ft³ reflect the loading of material in question in grams of the (catalytic) component volume of the monolith. To this effect, the monolith or honeycomb volume is calculated based on its cross-sectional area and length. As regards the further components which may be contained in the lean NOx trap catalyst in addition to the one or more components suitable for trapping NOx and preferably in addition to the one or more alkaline earth metals according to any of the particular and preferred embodiments of the present invention, no restrictions apply such that any conceivable one or more further components may be contained therein. According to the present invention it is however preferred that the lean NOx trap catalyst comprises one or more platinum group metals, and more preferably one or more platinum group metals selected from the group consisting of platinum, palladium, rhodium, iridium, and combinations of two or more thereof. More preferably, the lean NOx trap catalyst comprises one or more platinum group metals selected from the group consisting of platinum, palladium, rhodium, and combinations of two or more thereof, wherein more preferably, the lean NOx trap catalyst comprises platinum and more preferably platinum and palladium, wherein even more preferably platinum, palladium, and rhodium are contained as the platinum group metals in the lean NOx trap catalyst according to any of the particular and preferred embodiments of the present invention.

As regards the particular and preferred embodiments of the present invention wherein one or more platinum group metals are contained in the lean NOx trap catalyst and accordingly are contained in the portion of the catalyzed soot filter coated with the lean NOx trap catalyst extending from the inlet end to x % of the substrate axial length, no particular restrictions apply provided that the lean NOx trap catalyst may effectively trap NOx contained in exhaust gas. Thus, by way of example, the one or more platinum group metals contained in the portion of the catalyzed soot filter coated with the NOx trap catalyst extending from the inlet end to x % of the substrate axial length may be contained therein in an amount ranging anywhere from 1 to 200 g/ft³ of the one or more platinum group metals calculated as the element and based on the volume of the catalyzed soot filter measured from the inlet end up to x % of the substrate axial length. It is, however, preferred according to the present invention that the one or more platinum group metals are contained in the portion of the catalyzed soot filter coated with the lean NOx trap catalyst extending from the inlet end to x % of the substrate axial length in an amount in the range of from 5 to 150 g/ft³ of the one or more platinum group metals calculated as the element and based on the volume of the catalyzed soot filter measured from the inlet end up to x % of the substrate axial length, wherein more preferably the one or more platinum group metals are contained in the portion of the catalyzed soot filter coated with the lean NOx trap catalyst in an amount in the range of from 10 to 120 g/ft³, more preferably from 30 to 100 g/ft³, more preferably from 40 to 80 g/ft³, more preferably from 50 to 70 g/ft³, and more preferably from 55 to 65 g/ft³.

According to the present invention, it is particularly preferred that the lean NOx trap catalyst comprises platinum. According to said preferred embodiments, there is again no particular restriction according to the present invention as to the amounts of platinum which may be contained in the portion of the catalyzed soot filter coated with the lean NOx trap catalyst extending from the inlet end to x % of the substrate axial length. Thus, by way of example, platinum may be contained in the portion of the catalyzed soot filter coated with the lean NOx trap catalyst extending from the inlet end to x % of the substrate axial length in an amount ranging anywhere from 0.5 to 180 g/ft³ of platinum calculated as the element and based on the volume of the catalyzed soot filter measured from the inlet end up to x % of the substrate axial length, wherein it is preferred that platinum is contained in the portion of the catalyzed soot filter coated with the lean NOx trap catalyst in an amount in the range of from 1 to 140 g/ft³, more preferably from 5 to 110 g/ft³, more preferably from 10 to 90 g/ft³, more preferably from 30 to 70 g/ft³, more preferably from 40 to 60 g/ft³, more preferably from 50 to 55 g/ft³.

According to the present invention it is further preferred that the lean NOx trap catalyst comprises palladium, wherein palladium is contained in the portion of the catalyzed soot filter coated with the lean NOx trap catalyst extending from the inlet end to x % of the substrate axial length. As for the particular and preferred embodiments of the present invention comprising platinum in the lean NOx trap catalyst, there is again no particular restriction as to the amount in which palladium may be contained in the portion of the catalyzed soot filter coated with the NOx trap catalyst. Thus, by way of example, palladium contained in the portion of the catalyzed soot filter coated with the lean NOx trap catalyst according to particular and preferred embodiments of the present invention may be present in an amount ranging anywhere from 0.05 to 18 g/ft³ of palladium calculated as the element and based on the volume of the catalyzed soot filter measured from the inlet end up to x % of the substrate axial length, wherein preferably palladium is contained in the portion of the catalyzed soot filter coated with the lean NOx trap catalyst extending from the inlet end to x % of the substrate axial length in an amount in the range of from 0.1 to 15 g/ft³, more preferably from 0.5 to 12 g/ft³, more preferably from 1 to 10 g/ft³, more preferably from 3 to 8 g/ft³, more preferably from 4 to 6 g/ft³, more preferably from 4.5 to 5.5 g/ft³.

Finally, it is further preferred according to the present invention that the lean NOx trap catalyst comprises rhodium. As for the particular and preferred embodiments of the present invention comprising palladium and/or platinum in the lean NOx trap catalyst, there is again no particular restriction as to the amounts in which rhodium may be contained in the portion of the catalyzed soot filter coated with the lean NOx trap catalyst extending from the inlet end to x % of the substrate axial length. Thus, by way of example, rhodium may be contained in the portion of the catalyzed soot filter coated with the lean NOx trap catalyst extending form the inlet end to x % of the substrate axial length in an amount ranging anywhere from 0.05 to 18 g/ft³ of rhodium calculated as the element and based on the volume of the catalyzed soot filter measured from the inlet end up to x % of the substrate axial length, wherein preferably, rhodium is contained in the portion of the catalyzed soot filter coated with the lean NOx trap catalyst extending from the inlet end to x % of the substrate axial length in an amount in the range of from 0.1 to 15 g/ft³, more preferably from 0.5 to 12 g/ft³, more preferably from 1 to 10 g/ft³, more preferably from 3 to 8 g/ft³, more preferably from 4 to 6 g/ft³, more preferably from 4.5 to 5.5 g/ft³.

According to particular and preferred embodiments of the present invention wherein the lean NOx trap catalyst comprises one or more alkaline earth metals and/or one or more platinum group metals, the one or more alkaline earth metals and the one or more platinum group metals may respectively be provided on the wall flow substrate in any suitable fashion, such that independently from one another the one or more alkaline earth metals and the one or more platinum group metals may be contained directly on the wall flow substrate and/or may be contained in the catalyzed soot filter on a separate support material which is in turn provided on the wall flow substrate. It is, however, preferred according to the present invention that the one or more alkaline earth metals and/or the one or more platinum group metals and preferably the one or more alkaline earth metals and the one or more platinum group metals are supported on a support material and in particular on a particular support material which is in turn supported on the wall flow substrate of the catalyzed soot filter. Thus, according to particular and preferred embodiments of the present invention, it is preferred that the lean NOx trap catalyst comprises the one or more alkaline earth metals and/or, preferably and, the platinum group metals according to any of the preferred embodiments of the present invention on a particulate support material, respectively.

As regards the support which may be employed according to said particular and preferred embodiments, no particular restrictions apply such that any suitable particulate support material may be employed to these ends. Thus, by way of example, the particulate support on which the one or more alkaline earth metals and the one or more platinum group metals are respectively supported may, independently from one another, be selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is zirconia-alumina and/or magnesia-ceria-alumina.

According to the present invention it is particularly preferred that the lean NOx trap catalyst comprises both palladium and platinum, wherein said platinum group metals are supported on a particulate support material. According to said preferred embodiments, there is no restriction as to whether platinum and palladium are at least in part or entirely supported on the same particles, or whether platinum and palladium are supported on separate particles of the particulate support material. According to the invention it is however particularly preferred that platinum and palladium are supported on the same particles of the particulate support material, wherein more preferably the particulate support material is selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is magnesia-ceria-alumina, wherein preferably the magnesia-ceria-alumina consists of alumina which is doped with magnesia and ceria, wherein more preferably alumina is doped with from 1 to 30 wt.-% of magnesia based on 100 wt.-% of magnesia-ceria-alumina, more preferably from 5 to 25 wt.-% of magnesia, more preferably from 10 to 20 wt.-% of magnesia, more preferably from 12 to 18 wt.-% of magnesia, and more preferably from 14 to 16 wt.-% of magnesia, and independently thereof, with from 0.5 to 25 wt.-% of ceria based on 100 wt.-% of magnesia-ceria-alumina, more preferably from 1 to 20 wt.-% of ma ceria, more preferably from 5 to 15 wt.-% of ceria, more preferably from 7 to 12 wt.-% of ceria, and more preferably from 9 to 11 wt.-% of ceria.

Alternatively to the aforementioned particularly preferred embodiments or in addition thereto, the lean NOx trap catalyst comprises rhodium, wherein rhodium is preferably supported on a particulate support material. As for platinum and palladium, there is no particular restriction as to the type or number of particulate support materials on which rhodium may be supported, wherein it is preferred according to said particular and preferred embodiments of the present invention that rhodium is supported on a particulate support material selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is zirconia-alumina, wherein preferably the zirconia-alumina consists of alumina which is doped with zirconia, wherein more preferably alumina is doped with from 1 to 50 wt.-% of zirconia based on 100 wt.-% of zirconia-alumina, more preferably from 5 to 40 wt.-% of zirconia, more preferably from 10 to 30 wt.-% of zirconia, more preferably from 15 to 25 wt.-% of zirconia, and more preferably from 18 to 22 wt. % of zirconia.

As concerns particularly preferred embodiments of the present invention wherein the lean NOx trap catalyst comprises platinum, palladium, and rhodium, and wherein all of said components are provided on one or more particulate support materials, there is again no particular restriction as to whether one or more of said elements are at least in part or entirely supported on the same particles of one or more particulate support materials or whether two of the three platinum group metals are at least in part or entirely supported on particles of one or more particulate support materials and the third platinum group metal is supported on separate particles of a particulate support material. According to the present invention it is however particularly preferred that the lean NOx trap catalyst comprises platinum, palladium, and rhodium, wherein rhodium is supported on separate particles of the particulate support material than palladium and platinum.

As for the SCR catalyst, no particular restrictions apply relative to the size of the particulate support material onto which the one or more alkaline earth metals and/or the one or more platinum group metals according to any of the preferred and particularly preferred embodiments of the present invention are supported provided that the particles may be provided not only on the surface of the respective inlet and outlet channel walls but also on at least a portion of the surface of the pores within the channel walls underneath the surface of the channel walls. For achieving this, it is preferred that the average particle size D90 of the particulate support material onto which the one or more alkaline earth metals and/or one or more platinum group metals are supported is 25% or less of the average pore size of the walls of the substrate, Thus, by way of example, the average particle size D90 of the particulate support material may range anywhere from 0.5 to 25 μm, wherein preferably the average particle size D9 ranges from 1 to 20 μm, more preferably of from 3 to 15 μm, more preferably of from 6 to 12 μm, and more preferably of from 8 to 10 μm.

According to the present invention there is not particular restriction as to the amounts in which the particulate support material according to any of the particular and preferred embodiments of the present invention may be contained in the lean NOx trap catalyst. Thus, by way of example, the lean NOx trap catalyst may comprise the particulate support material in an amount ranging anywhere of from 0.05 to 5 g/in³ based on the volume of the catalyzed soot filter measured from the inlet end up to x % of the substrate axial length, wherein preferably the particulate support material is comprised in the lean NOx trap catalyst in an amount in the range of from 0.1 to 3 g/in³, more preferably from 0.5 to 2.5 g/in³, more preferably from 1.0 to 2 g/in³, more preferably from 1.3 to 1.8 g/in³, and more preferably from 1.4 to 1.6 g/in³. According to the present invention it is particularly preferred that the lean NOx trap catalyst comprises the particulate support material in an amount in the range of from 1.45 to 1.55 g/in³.

In addition to providing a catalyzed soot filter, the present invention further relates to a method of preparing a catalyzed soot filter and in particular to a method for preparing the inventive catalyzed soot filter according to any of the particular and preferred embodiments thereof as defined in the present application. Therefore, the present invention relates to a method of preparing a catalyzed soot filter and preferably to a method of preparing a catalyzed soot filter according to any of the particular and preferred embodiments of the present application, said method comprising

(i) providing a porous wall flow substrate comprising an inlet end, an outlet end, a substrate axial length extending between the inlet end and the outlet end, and a plurality of channels defined by internal walls of the wall flow substrate, wherein the plurality of channels comprise inlet channels having an open inlet end and a closed outlet end, and outlet channels having a closed inlet end and an open outlet end,
(ii) impregnating a particulate support material with an aqueous solution of a rhodium compound,
(iii) calcining the impregnated particulate support material obtained in (ii) for providing a supported Rh powder,
(iv) mixing a particulate support material with distilled water and subsequently adding an aqueous solution of a palladium compound and of a platinum compound thereto for providing a first slurry,
(v) adding the supported Rh powder, one or more oxygen storage materials, and one or more alkaline earth metal compounds to the first slurry obtained in (iv) for providing a second slurry,
(vi) optionally milling the second slurry, wherein said second slurry displays an average particle size D90 which is 25% or less of the average pore size of the walls of the porous wall flow substrate,
(vii) suspending a solid SCR catalyst in distilled water and optionally milling the resulting mixture for providing a third slurry, wherein said third slurry displays an average particle size D90 which is 25% or less of the average pore size of the walls of the porous wall flow substrate,
(viii) coating a portion of the inlet channel walls of the wall flow substrate by immersing the inlet end of the wall flow substrate into the second slurry up to x % of the substrate axial length extending from the inlet end with 0<x<100,
(ix) removing the wall flow substrate from the second slurry and removing excess slurry from the inlet channels, preferably by blowing air through the walls of the outlet channels into the coated inlet channels of the wall flow substrate,
(x) coating a portion of the outlet channel walls of the wall flow substrate by immersing the outlet end of the wall flow substrate into the third slurry up to 100-x % of the substrate axial length extending from the outlet end,
(xi) removing the wall flow substrate from the third slurry and removing excess slurry from the outlet channels, preferably by blowing air through the walls of the inlet channels into the coated outlet channels of the wall flow substrate,
(xii) optionally drying and/or calcining the coated wall flow substrate.

As regards the impregnation of the particulate support material in step (ii), there is no particular restriction according to the present invention as to how said impregnation may be achieved. It is, however, preferred according to the inventive method that the impregnation of the particulate support material (ii) with an aqueous solution of a rhodium compound is achieved by incipient wetness.

The inventive method for preparing a catalyzed soot filter comprises two steps of coating respective portions of the porous wall flow filter substrate as defined in (iiiv) and in (x). Between individual coating steps, and after having completed the coating of the porous wall flow substrate, excess slurry from the individual coating steps is respectively removed in steps (ix) and (xi). Finally, the coated porous wall flow substrate is preferably subject in optional step (xii) to a drying and/or calcining step. However, for ensuring that the individual coatings are sufficiently fixed to the wall flow substrate prior to the application of a further coating, it is preferred according to the inventive method that between steps (ix) and (x) the coated wall flow filter substrate is subject to a step of drying and/or calcining.

As regards the temperature which may be employed in the one or more preferred drying and/or calcining steps employed in the inventive method of preparing a catalyzed soot filter, no particular restrictions apply such that in principle any temperature may be employed for the drying and/or calcining of the coated porous wall flow substrate, respectively. Thus, as regards the drying steps, the individual steps may independently from one another be conducted at a temperature of drying comprised anywhere in the range of from 50 to 200° C., wherein it is preferred that independently of one another the temperature of drying in the one or more steps of drying is in the range of from 70 to 180° C., more preferably from 80 to 150° C., more preferably from 90 to 130° C., and more preferably from 100 to 120° C.

Same applies accordingly with respect to the temperature of calcining in the one or more steps of calcining which may range anywhere from 250 to 800° C., wherein it is preferred according to the inventive method that independently of one another the temperature of calcining in the one or more steps of calcining is in the range of from 300 to 600° C., more preferably of from 350 to 550° C., more preferably of from 400 to 500° C., more preferably of from 430 to 480° C., and more preferably of from 440 to 460° C.

With respect to the duration of the one or more calcining steps comprised by the inventive method, again no particular restrictions apply provided that a calcined coated porous wall flow substrate may be obtained. Thus, by way of example, the duration of calcining in the one or more steps of calcining may independently from one another range from 0.1 to 5 h, wherein it is preferred according to the inventive method that independently from one another the duration of calcining in the one or more steps of calcining is in the range of from 0.3 to 3 h, and more preferably of from 0.5 to 2 h, more preferably of from 0.7 to 1.5 h, more preferably of from 0.8 to 1.3 h, and more preferably of from 0.9 to 1.1 h.

As regards the extent to which the respective first and second slurries are provided on the respective inlet and outlet channel walls of the catalyzed soot filter according to the present invention, no particular restrictions apply such that in principle any portion of the inlet channel walls may be coated with the first slurry extending from the inlet end to less than the entire substrate axial length, and accordingly any portion of the outlet channel walls may be provided with the second slurry extending from the outlet end to a length less than the entire substrate axial length, provided that the length of the first slurry provided from the inlet end and the length of the second slurry provided from the outlet end amount to the substrate axial length, i.e. 100% thereof. Thus, by way of example, x may range anywhere from of from 5 to 95, wherein it is preferred that x ranges from 15 to 85, more preferably from 25 to 75, more preferably from 35 to 65, and more preferably from 45 to 55. According to the inventive method it is however alternatively preferred that x ranges from 5 to 65, wherein it is preferred that x ranges from 15 to 55, more preferably from 20 to 45, and more preferably from 25 to 35.

Concerning the rhodium compound which may be employed in step (ii) of the inventive method for impregnating the particulate support material for providing a supported rhodium powder, any conceivable rhodium compound may be employed to this effect, wherein it is preferred that the rhodium compound added as an aqueous solution in step (ii) is rhodium salt, and more preferably a rhodium salt selected from the group consisting of rhodium nitrate, rhodium sulfate, rhodium chloride, rhodium acetate, and mixtures of two or more thereof, wherein more preferably the rhodium salt is rhodium nitrate.

Concerning the palladium compound which may be employed in step (iv) of the inventive method for preparing the first slurry, any conceivable palladium compound may be employed to this effect wherein it is preferred that the palladium compound added as an aqueous solution in step (iv) is a palladium salt, and more preferably a palladium salt selected from the group consisting of palladium nitrate, palladium sulfate, palladium chloride, tetraaminepalladium chloride, and mixtures of two or more thereof, wherein more preferably the palladium salt is palladium nitrate.

Concerning the platinum compound which may be employed in step (iv) of the inventive method for preparing the first slurry, any conceivable platinum compound may be employed to this effect wherein it is preferred that the platinum compound added as an aqueous solution in step (iv) is a platinum salt, and more preferably a platinum salt selected from the group consisting of platinum nitrate, platinum sulfate, platinum chloride, platinum tetra monoethanolamine hydroxide, and mixtures of two or more thereof, wherein more preferably the platinum salt is palladium platinum tetra monoethanolamine hydroxide.

Regarding the porous wall flow substrate which may be employed in step (i) of the inventive method, no particular restrictions apply as to its shape and dimensions nor with respect to the material with which it is made. According to the present invention, it is, however, preferred that the porous wall flow substrate is a honeycomb substrate with alternately plugged inlet and outlet ends such that each wall of the wall flow substrate respectively has a first surface which is a surface of an inlet channel and a second surface which is a surface of an outlet channel.

Same applies accordingly relative to the porosity of the walls of the wall flow substrate which may be employed in step (i) of the inventive method such that said porosity may range anywhere from 40 to 85%, and preferably ranges from 45 to 80%, more preferably from 50 to 75%, more preferably from 55 to 70%, and more preferably in the range of from 60 to 65%. As regards the porosity as defined in the present application, it is preferred that said porosity is obtained via the mercury intrusion method, more preferably according to ISO 15901-1:2005.

As regards the average pore size of the walls of the wall flow substrate which may be employed in the inventive method in step (i), again no particular restrictions apply such that wall flow substrates displaying any suitable average pore size may be employed. Thus, by way of example, the average pore size of the walls of the substrate may be in the range of from 5 to 50 μm, and preferably in the range of from 10 to 40 μm, more preferably from 13 to 35 μm, more preferably from 15 to 30 μm, more preferably from 17 to 25 μm, and more preferably from 18 to 22 μm. As for the porosity, it is noted that the average pore size of the walls of the substrate the uncoated wall flow substrate, i.e. prior to providing the SCR catalyst and the palladium and platinum components thereon. Furthermore, as for the porosity of the substrate, also the average pore size of the walls as defined in the present application preferably refers to the average pore size as determined by mercury porosimetry, and more preferably obtained according to ISO 15901-1:2005.

As noted above, there is no particular restriction relative to the material of which the wall flow substrate provided in step (i) consists such that by way of example it may comprise one or more selected from the group consisting of metals, metal oxides, and ceramic materials, wherein preferably the material of which the wall flow filter consists comprises one or more selected from the group consisting of cordierite, aluminum titanate, silicon carbide, mullite, and mixtures of two or more thereof, wherein more preferably the wall flow substrate is made of cordierite, aluminum titanate, or silicon carbide, and preferably of silicon carbide.

As regards the solid SCR catalyst used in the method according to the present invention, no particular restriction applies relative to the materials contained therein provided that the selective catalytic reduction of NOx to N₂ via reduction with ammonia may be catalyzed by said material. Thus, any suitable SCR-active material may be comprised in the solid SCR catalyst. According to the present invention it is however preferred that the solid SCR catalyst comprises one or more zeolites, and more preferably one or more zeolites having a structure type selected from the group consisting of BEA, CHA, FAU, FER, HEU, LEV, MEI, MEL, MFI, MOR, including mixed structures and combinations of two or more thereof, more preferably from the group consisting of BEA, CHA, LEV, MFI, including mixed structures and combinations of two or more thereof, wherein more preferably the one or more zeolites are of the BEA and/or CHA structure type, preferably of the CHA structure type, wherein more preferably the one or more zeolites comprise chabazite, the one or more zeolites preferably being chabazite.

According to the present invention it is yet further preferred that the one or more zeolites comprised by the solid SCR catalyst used in (vii) according to any of the particular and preferred embodiments of the inventive method contain one or more transition metals. As regards the one or more transition metals preferably contained in the one or more zeolites preferably comprised by the solid SCR catalyst, no particular restrictions apply such that in principle any conceivable transition metal may be contained therein. It is, however, preferred according to the present invention that the one or more zeolites contain one or more transition metals selected from the group consisting of Pt, Pd, Rh, Cu, Co, Cr, Ni, Fe, V, Nb, and combinations of two or more thereof, more preferably one or more transition metals selected from the group consisting of Cu, Co, Cr, Ni, Fe, and combinations of two or more thereof, wherein more preferably the one or more zeolites contain Cu and/or Fe, preferably Cu.

Regarding the particular and preferred embodiments of the inventive method wherein the one or more zeolites preferably comprised in the solid SCR catalyst of the catalyzed soot filter contain one or more transition metals, there is no particular restriction as to the state in which the respective transition metals are contained in the one or more zeolites and in particular the method according to which the one or more transition metals are introduced into the zeolite. It is however preferred according to the present invention that the one or more transition metals contained in the one or more zeolites preferably comprised in the solid SCR catalyst have been introduced into the zeolite by ion-exchange and/or by impregnation, wherein it is particularly preferred that the one or more transition metals have been introduced therein by ion-exchange.

As regards the amount in which the one or more preferred zeolites optionally containing one or more transition metals are coated onto the wall flow substrate, no particular restriction applies such that these may be coated thereon in any suitable amount. Thus, by way of example, in steps (x) and (xi) the one or more zeolites optionally containing one or more transition metals may be coated onto the wall flow substrate in an amount ranging anywhere from 0.05 to 6 g/in³ calculated as the total weight of the one or more zeolites, optionally containing one or more transition metals, in the calcined state and based on the total volume of the catalyzed soot filter measured from the outlet end up to 100-x % of the substrate axial length, preferably from 0.1 to 5 g/in³. It is, however, preferred according to the present invention that the one or more zeolites optionally containing one or more transition are coated onto the wall flow substrate in an amount in the range of from 0.5 to 4 g/in³, more preferably from 0.8 to 3 g/in³, more preferably from 1 to 2.5 g/in³, and more preferably from 1.3 to 2 g/in³. According to the present invention it is particularly preferred that in steps (x) and (xi) the one or more preferred zeolites optionally containing one or more transition metals are coated onto the wall flow substrate in an amount in the range of from 1.5 to 1.9 g/in³.

Concerning the size of the particles of the solid SCR catalyst which is contained in the third slurry obtained in step (vii) no particular restrictions apply provided that the particles may be coated in (x) and (xi) not only on the surface of the inlet channel walls but also on at least a portion of the surface of the pores within the channel walls underneath the surface of the channel walls. For achieving this, it is preferred that the average particle size D90 of the solid SCR catalyst is 25% or less of the average pore size of the walls of the substrate. Thus, by way of example, the average particle size D90 of the solid SCR catalyst may range anywhere from 0.5 to 20 μm, wherein more preferably the average particle size D90 ranges from 1 to 15 μm, more preferably of from 3 to 10 μm, more preferably of from 4 to 8 μm, and more preferably of from 5 to 7 μm.

According to the present invention, there is no particular restriction as to the amounts of rhodium, palladium, or of platinum which may be coated onto the wall flow substrate in (viii) and (ix). Thus, as concerns rhodium, it may be coated onto the wall flow substrate in (viii) and (ix) from the inlet to x % of the substrate axial length in an amount ranging anywhere from 0.5 to 20 g/ft³ of rhodium calculated as the element and based on the volume of the catalyzed soot filter measured from the inlet end up to x % of the substrate axial length. According to the present invention it is however preferred that rhodium is coated onto the wall flow substrate extending from the inlet end to x % of the substrate axial length in an amount in the range of from 1 to 15 g/ft³, and more preferably from 2 to 10 g/ft³, more preferably from 2.5 to 8 g/ft³, more preferably from 3 to 7 g/ft³, more preferably from 3.5 to 6.5 g/ft³, more preferably from 4 to 6 g/ft³, and more preferably from 4.5 to 5.5 g/ft³. As concerns palladium, it may be coated onto the wall flow substrate in (viii) and (ix) from the inlet to x % of the substrate axial length in an amount ranging anywhere from 0.5 to 20 g/ft³ of palladium calculated as the element and based on the volume of the catalyzed soot filter measured from the inlet end up to x % of the substrate axial length. According to the present invention it is however preferred that palladium is coated onto the wall flow substrate extending from the inlet end to x % of the substrate axial length in an amount in the range of from 1 to 15 g/ft³, and more preferably from 2 to 10 g/ft³, more preferably from 2.5 to 8 g/ft³, more preferably from 3 to 7 g/ft³, more preferably from 3.5 to 6.5 g/ft³, more preferably from 4 to 6 g/ft³, and more preferably from 4.5 to 5.5 g/ft³.

Same applies accordingly relative to the amount of platinum such that it may for example be coated onto the wall flow substrate in steps (viii) and (ix) extending from the inlet end up to x % of the substrate axial length in an amount in the range of from 0.5 to 180 g/ft³ of platinum calculated as the element and based on the volume of the catalyzed soot filter measured from the inlet end up to x % of the substrate axial length. According to the present invention it is preferred that platinum is coated onto the wall flow substrate in steps (viii) and (ix) extending from the inlet end up to x % of the substrate axial length in an amount in the range of from 1 to 140 g/ft³, more preferably from 5 to 110 g/ft³, more preferably from 10 to 90 g/ft³, more preferably from 30 to 70 g/ft³, more preferably from 40 to 60 g/ft³, more preferably from 50 to 55 g/ft³.

As regards the particulate support material which may be employed in step (ii) for supporting rhodium, no particular restrictions apply such that any suitable particulate support material may be employed to this end. Thus, by way of example, the particulate support material onto which rhodium is supported may be selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is zirconia-alumina, wherein preferably the zirconia-alumina consists of alumina which is doped with zirconia, wherein more preferably alumina is doped with from 1 to 50 wt.-% of zirconia based on 100 wt.-% of zirconia-alumina, more preferably from 5 to 40 wt.-% of zirconia, more preferably from 10 to 30 wt.-% of zirconia, more preferably from 15 to 25 wt.-% of zirconia, and more preferably from 18 to 22 wt.-% of zirconia.

Concerning the particulate support material which may be employed in step (iv) for supporting palladium and platinum, again, no particular restrictions apply such that any suitable particulate support material may be employed to this end. Thus, by way of example, the particulate support material onto which palladium and platinum are supported may be selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is magnesia-ceria-alumina, wherein preferably the magnesia-ceria-alumina consists of alumina which is doped with magnesia and ceria, wherein more preferably alumina is doped with from 1 to 30 wt.-% of magnesia based on 100 wt.-% of magnesia-ceria-alumina, more preferably from 5 to 25 wt.-% of magnesia, more preferably from 10 to 20 wt.-% of magnesia, more preferably from 12 to 18 wt.-% of magnesia, and more preferably from 14 to 16 wt.-% of magnesia, and independently thereof, with from 0.5 to 25 wt.-% of ceria based on 100 wt.-% of magnesia-ceria-alumina, more preferably from 1 to 20 wt.-% of ma ceria, more preferably from 5 to 15 wt.-% of ceria, more preferably from 7 to 12 wt.-% of ceria, and more preferably from 9 to 11 wt.-% of ceria.

As for SCR catalyst, no particular restrictions apply relative to the size of the particulate support material onto which rhodium is supported in step (ii) and palladium and platinum are supported in step (iv) provided that the particles may respectively be coated in steps (viii) and (ix) not only on the surface of the inlet channel walls but also on at least a portion of the surface of the pores within the channel walls underneath the surface of the channel walls. For achieving this, it is preferred that the average particle size D90 of the particulate support material of steps (ii) and (iv) onto which rhodium and platinum and palladium are respectively supported is 25% or less of the average pore size of the walls of the substrate. Thus, by way of example, the average particle size D90 of the respective particulate support material may range anywhere from 0.5 to 25 μm, wherein preferably the average particle size D90 ranges from 1 to 20 μm, more preferably of from 3 to 15 μm, more preferably of from 6 to 12 μm, and more preferably of from 8 to 10 μm.

According to the present invention, there is no particular restriction as to the amounts in which in steps (viii) and (ix) the particulate support material according to any of the particular and preferred embodiments of the inventive method may be coated onto the wall flow substrate. Thus, by way of example, the particulate support material may be coated onto the wall flow substrate in steps (viii) and (ix) in an amount ranging anywhere from 0.05 to 5 Win′ based on the volume of the catalyzed soot filter measured from the inlet end up to x % of the substrate axial length, wherein preferably the particulate support material is coated in steps (viii) and (ix) in an amount in the range of from 0.1 to 3 g/in³, more preferably from 0.5 to 2.5 g/in³, more preferably from 1.0 to 2 g/in³, more preferably from 1.3 to 1.8 g/in³, more preferably from 1.4 to 1.6 g/in³, more preferably from 1.45 to 1.55 g/in³.

Same applies accordingly relative to the amount in which the solid SCR catalyst may be coated onto the wall flow substrate in steps (x) and (xi), wherein again no particular restrictions apply such that any suitable amount may be provided thereon. Thus, by way of example, the solid SCR catalyst may be coated onto the wall flow substrate in steps (x) and (xi) in an amount in the range of from 0.05 to 6 g/in³ based on the volume of the catalyzed soot filter measured from the outlet end up to 100-x % of the substrate axial length. According to the present invention, it is however preferred that in steps (x) and (xi) the solid SCR catalyst is coated onto the wall flow substrate in an amount in the range of from 0.1 to 5 g/in³, more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.

Besides providing a catalyzed soot filter according to any of the aforementioned particular and preferred embodiments described in the present application, the present application further relates to a catalyzed soot filter obtained and/or obtainable by the inventive method for preparing a catalyzed soot filter according to any of the particular and preferred embodiments thereof as defined in the present application. In particular, the present invention does not only relate to a catalyzed soot filter as may be directly obtained by the inventive method according to any particular and preferred embodiments thereof, i.e. the direct product thereof, but also to any catalyzed soot filter as may be obtained, i.e. as is obtainable according to the inventive method as defined in any of the particular and preferred embodiments thereof irrespective of the actual method according to which the catalyzed soot filter is obtained, provided that it may be obtained by the inventive method according to any of the particular and preferred embodiments thereof.

Furthermore, according to the present invention, the catalyzed soot filter according to any of the particular and preferred embodiments thereof as defined in the foregoing may be employed as such or in combination with one or more further catalytic and/or non-catalytic components in particular in an exhaust gas line or the like. Thus, the present invention further relates to an emissions treatment system wherein the inventive catalyzed soot filter according to any of the particular and preferred embodiments of the present invention is contained in said emissions treatment system.

Therefore, the present invention also relates to an emissions treatment system comprising a catalyzed soot filter (CSF) according to any of the particular and preferred embodiments as described in the present application or as obtainable and/or obtained according to any of the particular and preferred embodiments of the inventive method for the and a lean NOx trap (LNT) located upstream of the CSF, wherein the LNT and the CSF are in fluid communication with one another such that exhaust gas from an internal combustion engine may flow through the LNT and subsequently through the CSF, wherein the LNT comprises a flow through substrate comprising an inlet end, an outlet end, a substrate axial length extending between the inlet end and the outlet end, and a plurality of channels defined by internal walls of the wall flow substrate, and wherein the flow through substrate is coated with a second LNT catalyst. For sake of completeness it is herewith indicated that the term “second” for the lean NOx trap (LNT) catalyst contained in the LNT of the emissions treatments system serves to distinguish it from the lean NOx trap (LNT) catalyst contained in the catalyzed soot filter. Accordingly the lean NOx trap catalyst contained in the catalyzed soot filter according to any of the particular and preferred embodiments of the present invention may also be considered to constitute the “first” lean NOx trap catalyst when considered in combination with the LNT in the emissions treatment system according to any of the particular and preferred embodiments of the present invention. Consequently, unless specified as the second lean NOx trap catalyst or otherwise, the term “lean NOx trap catalyst” or “LNT catalyst” within the meaning of the present application is synonymous with a “first lean NOx trap” or “first LNT catalyst”, in particular when employed in the context of the emissions treatment system according to any of the particular and preferred embodiments of the present invention.

There is no particular restriction according to the present invention relative to the components which may be contained in the second lean NOx trap catalyst, provided that these are suitable for trapping NOx contained in exhaust gas as NO and/or NO₂ and preferably as NO, or do not impede the storage of NOx by other components contained in the second lean NOx trap catalyst. According to the present invention it is preferred that the second lean NOx trap catalyst comprises one or more alkaline earth metals and preferably one or more alkaline earth metals selected from the group consisting of Mg, Ca, Ba, Sr, and combinations of two or more thereof. According to the present invention it is yet further preferred that the second lean NOx trap catalyst comprises one or more alkaline earth metals selected from the group consisting of Mg, Ca, Ba, and combinations of two or more thereof, wherein even more preferably Mg and/or Ba, and preferably Mg and Ba are contained as the alkaline earth metal in the second lean NOx trap catalyst according to particular and preferred embodiments of the present invention. As regards the form in which the alkaline earth metals may be contained in the second lean NOx trap catalyst, no particular restrictions apply, wherein preferably the one or more alkaline earth metals according to the particular and preferred embodiments of the present invention are contained in the oxide form in the second lean NOx trap catalyst.

According to the present invention, there is no particular restriction as to the amounts of the one or more alkaline earth metals which are preferably contained in the second lean NOx trap catalyst. Thus, the one or more alkaline earth metals according to any of the particular and preferred embodiments of the present invention may be contained in the second lean NOx trap catalyst in an amount ranging anywhere from 0.05 to 2 g/in³ of the one or more alkaline earth metals calculated as the element and based on the total volume of the LNT. According to the present invention it is however preferred that the one or more alkaline earth metals are contained in the second lean NOx trap catalyst in an amount in the range of from 0.1 to 1.5 g/in³, and more preferably from 0.2 to 1 g/in³, more preferably from 0.25 to 0.7 g/in³, more preferably from 0.3 to 0.5 g/in³, more preferably from 0.35 to 0.45 g/in³, more preferably from 0.37 to 0.42 g/in³, and more preferably from 0.39 to 0.4 g/in³. It is again noted that within the meaning of the present application, the amounts of materials in the catalyzed soot filter and other catalyzed monoliths expressed in g/in³ or g/ft³ reflect the loading of material in question in grams of the (catalytic) component volume of the monolith. To this effect, the monolith or honeycomb volume is calculated based on its cross-sectional area and length.

As regards the further components which may be contained in the second lean NOx trap catalyst in addition to the one or more components suitable for trapping NOx and preferably in addition to the one or more alkaline earth metals according to any of the particular and preferred embodiments of the present invention, no restrictions apply such that any conceivable one or more further components may be contained therein. According to the present invention it is however preferred that the second lean NOx trap catalyst comprises one or more platinum group metals, and more preferably one or more platinum group metals selected from the group consisting of platinum, palladium, rhodium, iridium, and combinations of two or more thereof. More preferably, the second lean NOx trap catalyst comprises one or more platinum group metals selected from the group consisting of platinum, palladium, rhodium, and combinations of two or more thereof, wherein more preferably, the second lean NOx trap catalyst comprises platinum and more preferably platinum and palladium, wherein even more preferably platinum, palladium, and rhodium are contained as the platinum group metals in the second lean NOx trap catalyst according to any of the particular and preferred embodiments of the present invention.

As regards the particular and preferred embodiments of the present invention wherein one or more platinum group metals are contained in the second lean NOx trap catalyst, no particular restrictions apply provided that the lean NOx trap catalyst may effectively trap NOx contained in exhaust gas. Thus, by way of example, the one or more platinum group metals contained in the second NOx trap catalyst may be contained therein in an amount ranging anywhere from 1 to 200 g/ft³ of the one or more platinum group metals calculated as the element and based on the total volume of the LNT. It is, however, preferred according to the present invention that the one or more platinum group metals are contained in the second lean NOx trap catalyst in an amount in the range of from 10 to 400 g/ft³ of the one or more platinum group metals calculated as the element and based on the total volume of the LNT, wherein more preferably the one or more platinum group metals are contained in the second lean NOx trap catalyst in an amount in the range of from 30 to 300 g/ft³, more preferably from 50 to 250 g/ft³, more preferably from 80 to 220 g/ft³, more preferably from 100 to 200 g/ft³, more preferably from 130 to 180 g/ft³, more preferably from 140 to 160 g/ft³, and more preferably from 145 to 155 g/ft³.

According to the present invention, it is particularly preferred that the second lean NOx trap catalyst comprises platinum. According to said preferred embodiments, there is again no particular restriction according to the present invention as to the amounts in platinum which may be contained in the second lean NOx trap catalyst. Thus, by way of example, platinum may be contained in second lean NOx trap catalyst in an amount ranging anywhere from 5 to 400 g/ft³ of platinum calculated as the element and based on the total volume of the LNT, wherein it is preferred that platinum is contained in the portion of the catalyzed soot filter coated with the lean NOx trap catalyst in an amount in the range of from 10 to 300 g/ft³, more preferably from 30 to 250 g/ft³, more preferably from 50 to 200 g/ft³, more preferably from 80 to 180 g/ft³, more preferably from 100 to 150 g/ft³, more preferably from 120 to 130 g/ft³, and more preferably from 125 to 135 g/ft³.

According to the present invention it is further preferred that the second lean NOx trap catalyst comprises palladium. As for the particular and preferred embodiments of the present invention comprising platinum in the lean NOx trap catalyst, there is again no particular restriction as to the amount in which palladium may be contained in the second lean NOx trap catalyst. Thus, by way of example, palladium contained in the second lean NOx trap catalyst according to particular and preferred embodiments of the present invention may be present in an amount ranging anywhere from 1 to 50 g/ft³ of palladium calculated as the element and based on the total volume of the LNT, wherein preferably palladium is contained in the second lean NOx trap catalyst in an amount in the range of from 3 to 40 g/ft³, more preferably from 5 to 30 g/ft³, more preferably from 8 to 25 g/ft³, more preferably from 10 to 20 g/ft³, more preferably from 12 to 18 g/ft³, and more preferably from 14 to 16 g/ft³.

Finally, it is further preferred according to the present invention that the second lean NOx trap catalyst comprises rhodium. As for the particular and preferred embodiments of the present invention comprising palladium and/or platinum in the second lean NOx trap catalyst, there is again no particular restriction as to the amounts in which rhodium may be contained in the second lean NOx trap catalyst. Thus, by way of example, rhodium may be contained in the second lean NOx trap catalyst in an amount ranging anywhere from 0.1 to 20 g/ft³ of rhodium calculated as the element and based on the total volume of the LNT, wherein preferably, rhodium is contained in the second lean NOx trap catalyst in an amount in the range of from 0.5 to 15 g/ft³, more preferably from 1 to 10 g/ft³, more preferably from 3 to 8 g/ft³, more preferably from 4 to 6 g/ft³, more preferably from 4.5 to 5.5 g/ft³.

According to particular and preferred embodiments of the present invention wherein the second lean NOx trap catalyst comprises one or more alkaline earth metals and/or one or more platinum group metals, the one or more alkaline earth metals and the one or more platinum group metals may respectively be provided on the flow through substrate in any suitable fashion, such that independently from one another the one or more alkaline earth metals and the one or more platinum group metals may be contained directly on the flow through substrate and/or may be contained in the LNT on a separate support material which is in turn provided on the flow through substrate. It is, however, preferred according to the present invention that the one or more alkaline earth metals and/or the one or more platinum group metals and preferably the one or more alkaline earth metals and the one or more platinum group metals are supported on a support material and in particular on a particular support material which is in turn supported on the flow through substrate of the LNT. Thus, according to particular and preferred embodiments of the present invention, it is preferred that the second lean NOx trap catalyst comprises the one or more alkaline earth metals and/or, preferably and, the platinum group metals according to any of the preferred embodiments of the present invention on a particulate support material, respectively. As regards the support which may be employed according to said particular and preferred embodiments, no particular restrictions apply such that any suitable particulate support material may be employed to these ends. Thus, by way of example, the particulate support on which the one or more alkaline earth metals and the one or more platinum group metals are respectively supported may, independently from one another, be selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, lanthana-alumina, lanthana-zirconia-alumina, and mixtures of two or more thereof, more preferably from the group consisting of alumina, alumina-silica, zirconia-alumina, ceria, ceria-alumina, lanthana-alumina, lanthana-zirconia-alumina, and mixtures of two or more thereof, more preferably from the group consisting of alumina, ceria, ceria-alumina, and mixtures of two or more thereof, wherein more preferably the particulate support material is alumina and/or ceria, preferably γ-alumina.

According to the present invention it is particularly preferred that the second lean NOx trap catalyst comprises both palladium and platinum, wherein said platinum group metals are supported on a particulate support material. According to said preferred embodiments, there is no restriction as to whether platinum and palladium are at least in part or entirely supported on the same particles, or whether platinum and palladium are supported on separate particles of the particulate support material. According to the invention it is however particularly preferred that platinum and palladium are supported on the same particles of the particulate support material, wherein more preferably the particulate support material is selected from the group consisting of alumina, silica, alumina-silica, titania, titania-alumina, zirconia, zirconia-alumina, baria-alumina, ceria, ceria-alumina, baria-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria-alumina, baria-ceria-alumina, lanthana-alumina, lanthana-zirconia-alumina, and mixtures of two or more thereof, more preferably from the group consisting of alumina, alumina-silica, zirconia-alumina, lanthana-alumina, lanthana-zirconia-alumina, and mixtures of two or more thereof, wherein more preferably the particulate support material is alumina, preferably γ-alumina.

Alternatively to the aforementioned particularly preferred embodiments or in addition thereto, the second lean NOx trap catalyst comprises rhodium, wherein rhodium is preferably supported on a particulate support material. As for platinum and palladium, there is no particular restriction as to the type or number of particulate support materials on which rhodium may be supported, wherein it is preferred according to said particular and preferred embodiments of the present invention that rhodium is supported on a particulate support material selected from the group consisting of alumina, silica, alumina-silica, titania, titania-alumina, zirconia, zirconia-alumina, baria-alumina, ceria, ceria-alumina, baria-ceria-alumina, lanthana-alumina, lanthana-zirconia-alumina, titania-zirconia, and mixtures of two or more thereof, more preferably from the group consisting of alumina, alumina-silica, zirconia-alumina, ceria, ceria-alumina, lanthana-alumina, lanthana-zirconia-alumina, and mixtures of two or more thereof, wherein more preferably the particulate support material is ceria and/or ceria-alumina, preferably ceria.

As concerns particularly preferred embodiments of the present invention wherein the second lean NOx trap catalyst comprises platinum, palladium, and rhodium, and wherein all of said components are provided on one or more particulate support materials, there is again no particular restriction as to whether one or more of said elements are at least in part or entirely supported on the same particles of one or more particulate support materials or whether two of the three platinum group metals are at least in part or entirely supported on particles of one or more particulate support materials and the third platinum group metal is supported on separate particles of a particulate support material. According to the present invention it is however particularly preferred that the second lean NOx trap catalyst comprises platinum, palladium, and rhodium, wherein rhodium is supported on separate particles of the particulate support material than palladium and platinum.

According to the present invention, no particular restrictions apply relative to the size of the particulate support material onto which the one or more alkaline earth metals and/or the one or more platinum group metals according to any of the preferred and particularly preferred embodiments of the LNT of the emissions treatment system according to the present invention are supported. Thus, by way of example, the average particle size D90 of the particulate support material may range anywhere from 0.5 to 25 μm, wherein preferably the average particle size D9 ranges from 1 to 20 μm, more preferably of from 3 to 15 μm, more preferably of from 6 to 12 μm, and more preferably of from 8 to 10 μm.

According to the present invention there is not particular restriction as to the amounts in which the particulate support material according to any of the particular and preferred embodiments of the present invention may be contained in the second lean NOx trap catalyst. Thus, by way of example, the second lean NOx trap catalyst may comprise the particulate support material in an amount ranging anywhere of from 0.5 to 20 g/in³ based on the total volume of the LNT, wherein preferably the particulate support material is comprised in the second lean NOx trap catalyst in an amount in the range of from 1 to 15 g/in³, more preferably from 2 to 10 g/in³, more preferably from 3 to 8 g/in³, more preferably from 3.5 to 6 g/in³, more preferably from 4 to 5.5 g/in³, more preferably from 4.3 to 5.2 g/in³, more preferably from 4.5 to 5 g/in³, more preferably from 4.7 to 4.9 g/in³, and more preferably from 4.75 to 4.85 g/in³.

According to the present invention it is preferred that the emissions treatment system further comprises a diesel oxidation catalyst located upstream of the LNT, wherein the LNT is in fluid communication with the diesel oxidation catalyst such that exhaust gas from the combustion engine may flow through the diesel oxidation catalyst and subsequently through the LNT.

Although the inventive catalyzed soot filter is highly effective in the emissions treatment system utilizing passive SCR, it is not excluded that the emissions treatment system according to any of the particular and preferred embodiments of the present invention may further comprise a means of injecting a source of ammonia and/or one or more hydrocarbons into the exhaust gas stream from an internal combustion engine alternatively to the emissions treatment system wherein ammonia is generated in situ and/or in support of the passive SCR system depending on the specific needs for achieving NOx conversion at a particular point in time. Thus, it is preferred according to the present invention that the emissions treatment system further comprises a means of injecting a source of ammonia and/or one or more hydrocarbons into the exhaust gas stream from the internal combustion engine, wherein said injection means is located downstream of the LNT and upstream of the CSF.

Finally, it is preferred according the present invention that the emissions treatment system according to any of the particular and preferred embodiments thereof as defined in the foregoing further comprises an internal combustion engine, and preferably a lean burn internal combustion engine, wherein more preferably the internal combustion engine is a diesel engine.

Furthermore, the present invention also relates to a process for the treatment of emissions from an internal combustion engine comprising directing exhaust gas from an internal combustion engine through the inlet channel of a catalyzed soot filter according to any of the particular and preferred embodiments thereof as defined in the present application or by directing exhaust gas from an internal combustion engine through an emissions treatment system according to any of the particular and preferred embodiments thereof as defined in the present application.

Finally, the present invention relates to the use of a catalyzed soot filter according to any of the particular and preferred embodiments of the present invention as described in the present application including a catalyzed soot filter as obtained and/or obtainable according to any one of the particular and preferred embodiments of the inventive process as described in the present application. In addition, the present invention relates to the use of an emissions treatments system according to any of the particular and preferred embodiments of the present invention as described in the present application. With respect to the inventive use, there is no restriction whatsoever relative to the application in which the aforementioned catalyzed soot filter or emissions treatment system may be employed wherein independently from one another the catalyzed soot filter or the emissions treatment system may be used for the treatment of exhaust gas emissions, and preferably for the simultaneous treatment of NON, hydrocarbons, and carbon monoxide in exhaust gas from an internal combustion engine, more preferably for the storage and conversion of NOx and/or for the selective catalytic reduction of NOx and/or for the oxidation of hydrocarbons and carbon monoxide in exhaust gas from an internal combustion engine and more preferably for the simultaneous storage and conversion of NOx, selective catalytic reduction of NOx, and oxidation of hydrocarbons and carbon monoxide in exhaust gas from an internal combustion engine. According to the present invention it is particularly preferred that the catalyzed soot filter according to any of the particular and preferred embodiments as described in the present application or the emissions treatment system according to any of the particular and preferred embodiments as described in the present application is used for the selective catalytic reduction of NOx in exhaust gas from a diesel engine.

The present invention is further characterized by the following and particular preferred embodiments, including the combination and embodiments indicated by the respective dependencies:
1. A catalyzed soot filter (CSF), wherein the CSF comprises a porous wall flow substrate, a lean NOx trap (LNT) catalyst, and a catalyst for selective catalytic reduction (SCR),
   the wall flow substrate comprising an inlet end, an outlet end, a substrate axial length extending between the inlet end and the outlet end, and a plurality of channels defined by internal walls of the wall flow substrate, wherein the plurality of channels comprise inlet channels having an open inlet end and a closed outlet end, and outlet channels having a closed inlet end and an open outlet end,
   wherein the LNT catalyst is provided on a portion of the surface of the inlet channel walls and on at least a portion of the surface of the pores within the channel walls underneath the surface of the channel walls coated with the LNT catalyst, wherein the portion of the inlet channel walls coated with the LNT catalyst extends from the inlet end to x % of the substrate axial length with 0<x<100,
   wherein the SCR catalyst is provided on a portion of the surface of the outlet channel walls and on at least a portion of the surface of the pores within the channel walls underneath the surface of the channel walls coated with the SCR catalyst, wherein the portion of the outlet channel walls coated with the SCR catalyst extends from the outlet end to 100-x % of the substrate axial length.
2. The catalyzed soot filter of embodiment 1, wherein x is in the range of from 5 to 95, preferably from 15 to 85, more preferably from 25 to 75, more preferably from 35 to 65, and more preferably from 45 to 55.
3. The catalyzed soot filter of embodiment 1 or 2, wherein the porous wall flow substrate is a honeycomb substrate with alternately plugged inlet and outlet ends such that each wall of the wall flow substrate respectively has a first surface which is a surface of an inlet channel and a second surface which is a surface of an outlet channel.
4. The catalyzed soot filter of any of embodiments 1 to 3, wherein the walls of the substrate display a porosity in the range of from 40 to 85%, preferably from 45 to 80%, more preferably from 50 to 75%, more preferably from 55 to 70%, and more preferably in the range of from 60 to 65%.
5. The catalyzed soot filter of any of embodiments 1 to 4, wherein the average pore size of the walls of the substrate is in the range of from 5 to 50 μm, preferably from 10 to 40 μm, more preferably from 13 to 35 μm, more preferably from 15 to 30 μm, more preferably from 17 to 25 μm, and more preferably from 18 to 22 μm.
6. The catalyzed soot filter of any of embodiments 1 to 5, wherein the material of which the wall flow substrate consists comprises one or more selected from the group consisting of metals, metal oxides, and ceramic materials, preferably one or more selected from the group consisting of cordierite, aluminum titanate, silicon carbide, mullite, and mixtures of two or more thereof, wherein more preferably the wall flow substrate is made of cordierite, aluminum titanate, or silicon carbide, and preferably of silicon carbide.
7. The catalyzed soot filter of any of embodiments 1 to 6, wherein the LNT catalyst is provided on at least a portion of the surface of the pores within the channel walls underneath the surface of the channel walls coated with the LNT catalyst extending from the surface of the inlet channel walls coated with the LNT catalyst to a depth of 10% or more of the thickness of the walls of the uncoated substrate, preferably to a depth of 15% or more, more preferably to a depth of 20% or more, more preferably of 35% or more, more preferably of 40% or more, more preferably of 50% or more, and more preferably to a depth of 70% or more of the thickness of the walls of the uncoated substrate.
8. The catalyzed soot filter of any of embodiments 1 to 7, wherein the SCR catalyst is provided on at least a portion of the surface of the pores within the channel walls underneath the surface of the portions of the channel walls coated with the SCR catalyst extending from the surface of the outlet channel walls coated with the SCR catalyst to a depth of 10% or more of the thickness of the walls of the uncoated substrate, preferably to a depth of 15% or more, more preferably to a depth of 20% or more, more preferably of 35% or more, more preferably of 40% or more, more preferably of 50% or more, and more preferably to a depth of 70% or more of the thickness of the walls of the uncoated substrate.
9. The catalyzed soot filter of any of embodiments 1 to 8, wherein the SCR catalyst comprises one or more zeolites, preferably one or more zeolites having a structure type selected from the group consisting of BEA, CHA, FAU, FER, HEU, LEV, MEI, MEL, MFI, MOR, including mixed structures and combinations of two or more thereof, more preferably from the group consisting of BEA, CHA, LEV, MFI, including mixed structures and combinations of two or more thereof, wherein more preferably the one or more zeolites are of the BEA and/or CHA structure type, preferably of the CHA structure type, wherein more preferably the one or more zeolites comprise chabazite, the one or more zeolites preferably being chabazite.
10. The catalyzed soot filter of embodiment 9, wherein the one or more zeolites contain one or more transition metals, preferably one or more transition metals selected from the group consisting of Pt, Pd, Rh, Cu, Co, Cr, Ni, Fe, V, Nb, and combinations of two or more thereof, more preferably one or more transition metals selected from the group consisting of Cu, Co, Cr, Ni, Fe, and combinations of two or more thereof, wherein more preferably the one or more zeolites contain Cu and/or Fe, preferably Cu.
11. The catalyzed soot filter of embodiment 10, wherein the one or more transition metals have been introduced into the zeolite by ion-exchange and/or by impregnation, preferably by ion-exchange.
12. The catalyzed soot filter of embodiment 10 or 11, wherein the one or more zeolites optionally containing one or more transition metals are contained in the portion of the catalyzed soot filter coated with the SCR catalyst extending from the outlet end to 100-x % of the substrate axial length in an amount in the range of from 0.05 to 6 g/in³ calculated as the total weight of the one or more zeolites, optionally containing one or more transition metals, in the calcined state and based on the volume of the catalyzed soot filter measured from the outlet end up to 100-x % of the substrate axial length, preferably from 0.1 to 5 g/in³, more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.
13. The catalyzed soot filter of any of embodiments 1 to 12, wherein the average particle size D90 of the SCR catalyst is 25% or less of the average pore size of the walls of the substrate and is preferably in the range of from 0.5 to 20 μm, more preferably of from 1 to 15 μm, more preferably of from 3 to 10 μm, more preferably of from 4 to 8 μm, and more preferably of from 5 to 7 μm.
14. The catalyzed soot filter of any of embodiments 1 to 13, wherein the LNT catalyst is contained in the portion of the catalyzed soot filter coated with the LNT catalyst extending from the inlet end to x % of the substrate axial length in an amount in the range of from 0.05 to 6 g/in³ based on the volume of the catalyzed soot filter measured from the inlet end up to x % of the substrate axial length, preferably in an amount in the range of from 0.1 to 5 g/in³, more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.
15. The catalyzed soot filter of any of embodiments 1 to 14, wherein the LNT catalyst comprises one or more alkaline earth metals, preferably one or more alkaline earth metals selected from the group consisting of Mg, Ca, Ba, Sr, and combinations of two or more thereof, more preferably from the group consisting of Mg, Ca, Ba, and combinations of two or more thereof, wherein more preferably the LNT catalyst comprises Mg and/or Ba, preferably Ba.
16. The catalyzed soot filter of embodiment 15, wherein the one or more alkaline earth metals are contained in the portion of the CSF coated with the LNT catalyst extending from the inlet end to x % of the substrate axial length in an amount in the range of from 0.01 to 2 g/in³ of the one or more alkaline earth metals calculated as the oxide and based on the volume of the CSF measured from the inlet end up to x % of the substrate axial length, preferably in an amount in the range of from 0.05 to 1 g/in³, more preferably from 0.1 to 0.8 g/in³, more preferably from 0.15 to 0.6 g/in³, more preferably from 0.2 to 0.45 g/in³, more preferably from 0.25 to 0.38 g/in³, more preferably from 0.28 to 0.35 g/in³, more preferably from 0.30 to 0.33 g/in³, more preferably from 0.31 to 0.32 g/in³.
17. The catalyzed soot filter of any of embodiments 1 to 16, wherein the LNT catalyst comprises one or more oxygen storage components, wherein preferably the one or more oxygen storage components are selected from the group consisting of zirconia, ceria, lanthana, praseodymia, neodymia, and mixtures thereof, wherein the one or more oxygen storage components preferably comprise ceria and/or praseodymia, more preferably ceria, wherein more preferably ceria and/or praseodymia, and more preferably ceria is contained as the one or more oxygen storage components in the LNT catalyst.
18. The catalyzed soot filter of embodiment 17, wherein the one or more oxygen storage components are contained in the portion of the CSF coated with the LNT catalyst extending from the inlet end to x % of the substrate axial length in an amount in the range of from 0.01 to 3 g/in³ based on the volume of the CSF measured from the inlet end up to x % of the substrate axial length, preferably in an amount in the range of from 0.05 to 2 g/in³, more preferably from 0.1 to 1.5 g/in³, more preferably from 0.2 to 1.2 g/in³, more preferably from 0.3 to 1 g/in³, more preferably from 0.4 to 0.8 g/in³, more preferably from 0.45 to 0.7 g/in³, more preferably from 0.5 to 0.6 g/in³, more preferably from 0.53 to 0.55 g/in³.
19. The catalyzed soot filter of any of embodiments 1 to 18, wherein the SCR catalyst is contained in the portion of the catalyzed soot filter coated with the SCR catalyst extending from the outlet end to 100-x % of the substrate axial length in an amount in the range of from 0.05 to 6 g/in³ based on the volume of the CSF measured from the outlet end up to 100-x % of the substrate axial length, preferably in an amount in the range of from 0.1 to 5 g/in³, more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.
20. The catalyzed soot filter of any of embodiments 1 to 19, wherein the LNT catalyst comprises one or more platinum group metals, preferably one or more platinum group metals selected from the group consisting of Pt, Pd, Rh, Ir, and combinations of two or more thereof, more preferably from the group consisting of Pt, Pd, Rh, and combinations of two or more thereof, wherein more preferably, the LNT catalyst comprises Pt, more preferably Pt and Pd, and more preferably Pt, Pd, and Rh.
21. The catalyzed soot filter of embodiment 20, wherein the one or more platinum group metals are contained in the portion of the CSF coated with the LNT catalyst extending from the inlet end to x % of the substrate axial length in an amount in the range of from 1 to 200 g/ft³ of the one or more platinum group metals calculated as the element and based on the volume of the CSF measured from the inlet end up to x % of the substrate axial length, preferably in an amount in the range of from 5 to 150 g/ft³, more preferably from 10 to 120 g/ft³, more preferably from 30 to 100 g/ft³, more preferably from 40 to 80 g/ft³, more preferably from 50 to 70 g/ft³, and more preferably from 55 to 65 g/ft³.
22. The catalyzed soot filter of any of embodiments 1 to 21, wherein the LNT catalyst comprises platinum, wherein platinum is contained in the portion of the CSF coated with the LNT catalyst extending from the inlet end to x % of the substrate axial length in an amount in the range of from 0.5 to 180 g/ft³ of platinum calculated as the element and based on the volume of the CSF measured from the inlet end up to x % of the substrate axial length, preferably in an amount in the range of from 1 to 140 g/ft³, more preferably from 5 to 110 g/ft³, more preferably from 10 to 90 g/ft³, more preferably from 30 to 70 g/ft³, more preferably from 40 to 60 g/ft³, more preferably from 50 to 55 g/ft³.
23. The catalyzed soot filter of any of embodiments 1 to 22, wherein the LNT catalyst comprises palladium, wherein palladium is contained in the portion of the CSF coated with the LNT catalyst extending from the inlet end to x % of the substrate axial length in an amount in the range of from 0.05 to 18 g/ft³ of palladium calculated as the element and based on the volume of the CSF measured from the inlet end up to x % of the substrate axial length, preferably in an amount in the range of from 0.1 to 15 g/ft³, more preferably from 0.5 to 12 g/ft³, more preferably from 1 to 10 g/ft³, more preferably from 3 to 8 g/ft³, more preferably from 4 to 6 g/ft³, more preferably from 4.5 to 5.5 g/ft³.
24. The catalyzed soot filter of any of embodiments 1 to 23, wherein the LNT catalyst comprises rhodium, wherein rhodium is contained in the portion of the CSF coated with the LNT catalyst extending from the inlet end to x % of the substrate axial length in an amount in the range of from 0.05 to 18 g/ft³ of rhodium calculated as the element and based on the volume of the CSF measured from the inlet end up to x % of the substrate axial length, preferably in an amount in the range of from 0.1 to 15 g/ft³, more preferably from 0.5 to 12 g/ft³, more preferably from 1 to 10 g/ft³, more preferably from 3 to 8 g/ft³, more preferably from 4 to 6 g/ft³, more preferably from 4.5 to 5.5 g/ft³.
25. The catalyzed soot filter of any of embodiments 15 to 24, wherein the one or more alkaline earth metals and/or, preferably and, the one or more platinum group metals contained in the LNT catalyst are supported on a particulate support material, wherein the particulate support material is preferably selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is zirconia-alumina and/or magnesia-ceria-alumina.
26. The catalyzed soot filter of embodiment 25, wherein the LNT catalyst comprises platinum and palladium, wherein platinum and palladium are supported on the same particles of the particulate support material, wherein preferably the particulate support material is selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is magnesia-ceria-alumina, wherein preferably the magnesia-ceria-alumina consists of alumina which is doped with magnesia and ceria, wherein more preferably alumina is doped with from 1 to 30 wt.-% of magnesia based on 100 wt.-% of magnesia-ceria-alumina, more preferably from 5 to 25 wt.-% of magnesia, more preferably from 10 to 20 wt.-% of magnesia, more preferably from 12 to 18 wt.-% of magnesia, and more preferably from 14 to 16 wt.-% of magnesia, and independently thereof, with from 0.5 to 25 wt.-% of ceria based on 100 wt.-% of magnesia-ceria-alumina, more preferably from 1 to 20 wt.-% of ma ceria, more preferably from 5 to 15 wt.-% of ceria, more preferably from 7 to 12 wt.-% of ceria, and more preferably from 9 to 11 wt.-% of ceria.
27. The catalyzed soot filter of embodiment 25 or 26, wherein the LNT catalyst comprises rhodium, wherein rhodium is supported on a particulate support material selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is zirconia-alumina, wherein preferably the zirconia-alumina consists of alumina which is doped with zirconia, wherein more preferably alumina is doped with from 1 to 50 wt.-% of zirconia based on 100 wt.-% of zirconia-alumina, more preferably from 5 to 40 wt.-% of zirconia, more preferably from 10 to 30 wt.-% of zirconia, more preferably from 15 to 25 wt.-% of zirconia, and more preferably from 18 to 22 wt.-% of zirconia.
28. The catalyzed soot filter of any of embodiments 25 to 27, wherein the LNT catalyst comprises platinum, palladium, and rhodium, wherein rhodium is supported on separate particles of the particulate support material than palladium and platinum.
29. The catalyzed soot filter of any of embodiments 25 to 28, wherein independently from one another the average particle size D90 of the particulate support material is 25% or less of the average pore size of the walls of the substrate and is preferably in the range of from 0.5 to 25 μm, more preferably of from 1 to 20 μm, more preferably of from 3 to 15 μm, more preferably of from 6 to 12 μm, and more preferably of from 8 to 10 μm.
30. The catalyzed soot filter of any of embodiments 25 to 29, wherein the LNT catalyst comprises the particulate support material in an amount in the range of from 0.05 to 5 g/in³ based on the volume of the catalyzed soot filter measured from the inlet end up to x % of the substrate axial length, preferably from 0.1 to 3 g/in³, more preferably from 0.5 to 2.5 g/in³, more preferably from 1.0 to 2 g/in³, more preferably from 1.3 to 1.8 g/in³, more preferably from 1.4 to 1.6 g/in³, more preferably from 1.45 to 1.55 g/in³.
31. A method of preparing a catalyzed soot filter, preferably of a catalyzed soot filter according to any of embodiments 1 to 30, comprising
   (i) providing a porous wall flow substrate comprising an inlet end, an outlet end, a substrate axial length extending between the inlet end and the outlet end, and a plurality of channels defined by internal walls of the wall flow substrate, wherein the plurality of channels comprise inlet channels having an open inlet end and a closed outlet end, and outlet channels having a closed inlet end and an open outlet end,
   (ii) impregnating a particulate support material with an aqueous solution of a rhodium compound,
   (iii) calcining the impregnated particulate support material obtained in (ii) for providing a supported Rh powder,
   (iv) mixing a particulate support material with distilled water and subsequently adding an aqueous solution of a palladium compound and of a platinum compound thereto for providing a first slurry,
   (v) adding the supported Rh powder, one or more oxygen storage materials, and one or more alkaline earth metal compounds to the first slurry obtained in (iv) for providing a second slurry,
   (vi) optionally milling the second slurry, wherein said second slurry displays an average particle size D90 which is 25% or less of the average pore size of the walls of the porous wall flow substrate,
   (vii) suspending a solid SCR catalyst in distilled water and optionally milling the resulting mixture for providing a third slurry, wherein said third slurry displays an average particle size D90 which is 25% or less of the average pore size of the walls of the porous wall flow substrate,
   (viii) coating a portion of the inlet channel walls of the wall flow substrate by immersing the inlet end of the wall flow substrate into the second slurry up to x % of the substrate axial length extending from the inlet end with 0<x<100,
   (ix) removing the wall flow substrate from the second slurry and removing excess slurry from the inlet channels, preferably by blowing air through the walls of the outlet channels into the coated inlet channels of the wall flow substrate,
   (x) coating a portion of the outlet channel walls of the wall flow substrate by immersing the outlet end of the wall flow substrate into the third slurry up to 100-x % of the substrate axial length extending from the outlet end,
   (xi) removing the wall flow substrate from the third slurry and removing excess slurry from the outlet channels, preferably by blowing air through the walls of the inlet channels into the coated outlet channels of the wall flow substrate,
   (xii) optionally drying and/or calcining the coated wall flow substrate.
32. The method of embodiment 31, wherein the impregnation in (ii) is achieved by incipient wetness.
33. The method of embodiment 31 or 32, wherein between steps (ix) and (x) the coated wall flow filter substrate is subject to a step of drying and/or calcining.
34. The method of any of embodiments 31 to 33, wherein independently of one another the temperature of drying in the one or more steps of drying is in the range of from 50 to 200° C., preferably from 70 to 180° C., more preferably from 80 to 150° C., more preferably from 90 to 130° C., and more preferably from 100 to 120° C.
35. The method of any of embodiments 31 to 34, wherein independently of one another the temperature of calcining in the one or more steps of calcining is in the range of from 250 to 800° C., preferably of from 300 to 600° C., more preferably of from 350 to 550° C., more preferably of from 400 to 500° C., more preferably of from 430 to 480° C., and more preferably of from 440 to 460° C.
36. The method of any of embodiments 31 to 35 wherein independently from one another, the duration of calcining in the one or more steps of calcining is in the range of from 0.1 to 5 h, preferably of from 0.3 to 3 h, more preferably of from 0.5 to 2 h, more preferably of from 0.7 to 1.5 h, more preferably of from 0.8 to 1.3 h, and more preferably of from 0.9 to 1.1 h.
37. The method of any of embodiments 31 to 36, wherein x is in the range of from 5 to 95, preferably from 15 to 85, more preferably from 25 to 75, more preferably from 35 to 65, and more preferably from 45 to 55.
38. The method of any of embodiments 31 to 37, wherein in step (ii) the rhodium compound is a rhodium salt, preferably a rhodium salt selected from the group consisting of rhodium nitrate, rhodium sulfate, rhodium chloride, rhodium acetate, and mixtures of two or more thereof, wherein more preferably the rhodium salt is rhodium nitrate.
39. The method of any of embodiments 31 to 38, wherein in step (iv) the palladium compound is a palladium salt, preferably a palladium salt selected from the group consisting of palladium nitrate, palladium sulfate, palladium chloride, tetraaminepalladium chloride, and mixtures of two or more thereof, wherein more preferably the palladium salt is palladium nitrate.
40. The method of any of embodiments 31 to 39, wherein in step (iv) the platinum compound is a platinum salt, preferably a platinum salt selected from the group consisting of platinum nitrate, platinum sulfate, platinum chloride, platinum tetra monoethanolamine hydroxide, and mixtures of two or more thereof, wherein more preferably the platinum salt is palladium platinum tetra monoethanolamine hydroxide.
41. The method of any of embodiments 31 to 40, wherein the one or more oxygen storage materials added in step (v) are selected from the group consisting of zirconia, ceria, lanthana, praseodymia, neodymia, and mixtures thereof, wherein preferably the one or more oxygen storage materials comprise ceria and/or praseodymia, more preferably ceria, wherein more preferably ceria and/or praseodymia, and more preferably ceria is added as the one or more oxygen storage materials in step (v).
42. The method of any of embodiments 31 to 41, wherein the one or more alkaline earth metals added in step (v) are selected from the group consisting of Mg, Ca, Ba, Sr, and combinations of two or more thereof, more preferably from the group consisting of Mg, Ca, Ba, and combinations of two or more thereof, wherein more preferably Mg and/or Ba, and preferably Ba is added as the one or more alkaline earth metals in step (v).
43. The method of any of embodiments 31 to 42, wherein the porous wall flow substrate provided in step (i) is a honeycomb substrate with alternately plugged inlet and outlet ends such that each wall of the wall flow substrate respectively has a first surface which is a surface of an inlet channel and a second surface which is a surface of an outlet channel
44. The method of any of embodiments 31 to 43, wherein the walls of the porous wall flow substrate provided in step (i) display a porosity in the range of from 40 to 85%, preferably from 45 to 80%, more preferably from 50 to 75%, more preferably from 55 to 70%, and more preferably in the range of from 60 to 65%.
45. The method of any of embodiments 31 to 44, wherein the average pore size of the walls of the porous wall flow substrate provided in step (i) is in the range of from 5 to 50 μm, preferably from 10 to 40 μm, more preferably from 13 to 35 μm, more preferably from 15 to 30 μm, more preferably from 17 to 25 μm, and more preferably from 18 to 22 μm.
46. The method of any of embodiments 31 to 45, wherein the material of which the porous wall flow substrate provided in step (i) consists comprises one or more selected from the group consisting of metals, metal oxides, and ceramic materials, preferably one or more selected from the group consisting of cordierite, aluminum titanate, silicon carbide, mullite, and mixtures of two or more thereof, wherein more preferably the wall flow substrate is made of cordierite, aluminum titanate, or silicon carbide, and preferably of silicon carbide.
47. The method of any of embodiments 31 to 46, wherein the solid SCR catalyst comprises one or more zeolites, preferably one or more zeolites having a structure type selected from the group consisting of BEA, CHA, FAU, FER, HEU, LEV, MEI, MEL, MFI, MOR, including mixed structures and combinations of two or more thereof, more preferably from the group consisting of BEA, CHA, LEV, MFI, including mixed structures and combinations of two or more thereof, wherein more preferably the one or more zeolites are of the BEA and/or CHA structure type, preferably of the CHA structure type, wherein more preferably the one or more zeolites comprise chabazite, the one or more zeolites preferably being chabazite
48. The method of embodiment 47, wherein the one or more zeolites contain one or more transition metals, preferably one or more transition metals selected from the group consisting of

Pt, Pd, Rh, Cu, Co, Cr, Ni, Fe, V, Nb, and combinations of two or more thereof, more preferably one or more transition metals selected from the group consisting of Cu, Co, Cr, Ni, Fe, and combinations of two or more thereof, wherein more preferably the one or more zeolites contain Cu and/or Fe, preferably Cu.
49. The method of embodiment 48, wherein the one or more transition metals have been introduced into the zeolite by ion-exchange and/or by impregnation, preferably by ion-exchange.
50. The method of any of embodiments 47 to 49, wherein in steps (x) and (xi) the one or more zeolites optionally containing one or more transition metals are coated onto the wall flow substrate in an amount in the range of from 0.05 to 6 g/in³ calculated as the total weight of the one or more zeolites, optionally containing one or more transition metals, in the calcined state and based on the volume of the catalyzed soot filter measured from the outlet end up to 100-x % of the substrate axial length, preferably from 0.1 to 5 g/in³, more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.
51. The method of any of embodiments 31 to 50, wherein in step (vii) the average particle size D90 of the solid SCR catalyst is in the range of from 0.5 to 20 μm, preferably of from 1 to 15 μm, more preferably of from 3 to 10 μm, more preferably of from 4 to 8 μm, and more preferably of from 5 to 7 μm.
52. The method of any of embodiments 31 to 51, wherein in steps (viii) and (ix) rhodium is coated onto the wall flow substrate in an amount in the range of from 0.05 to 18 g/ft³ of rhodium calculated as the element and based on the volume of the catalyzed soot filter measured from the inlet end up to x % of the substrate axial length, preferably in an amount in the range of from 0.1 to 15 g/ft³, more preferably from 0.5 to 12 g/ft³, more preferably from 1 to 10 g/ft³, more preferably from 3 to 8 g/ft³, more preferably from 4 to 6 g/ft³, more preferably from 4.5 to 5.5 g/ft³.
53. The method of any of embodiments 31 to 52, wherein in steps (viii) and (ix) palladium is coated onto the wall flow substrate in an amount in the range of from 0.05 to 18 g/ft³ of palladium calculated as the element and based on the volume of the catalyzed soot filter measured from the inlet end up to x % of the substrate axial length, preferably in an amount in the range of from 0.1 to 15 g/ft³, more preferably from 0.5 to 12 g/ft³, more preferably from 1 to 10 g/ft³, more preferably from 3 to 8 g/ft³, more preferably from 4 to 6 g/ft³, more preferably from 4.5 to 5.5 g/ft³.
54. The method of any of embodiments 31 to 53, wherein in steps (viii) and (ix) platinum is coated onto the wall flow substrate in an amount in the range of from 0.5 to 180 g/ft³ of platinum calculated as the element and based on the volume of the catalyzed soot filter measured from the inlet end up to x % of the substrate axial length, preferably in an amount in the range of from 1 to 140 g/ft³, more preferably from 5 to 110 g/ft³, more preferably from 10 to 90 g/ft³, more preferably from 30 to 70 g/ft³, more preferably from 40 to 60 g/ft³, more preferably from 50 to 55 g/ft³.
55. The method of any of embodiments 31 to 54, wherein in steps (viii) and (ix) the one or more oxygen storage components are coated onto the wall flow substrate in an amount in the range of from 0.01 to 3 Win′ based on the volume of the catalyzed soot filter measured from the inlet end up to x % of the substrate axial length, preferably in an amount in the range of from 0.05 to 2 g/in³, more preferably from 0.1 to 1.5 g/in³, more preferably from 0.2 to 1.2 g/in³, more preferably from 0.3 to 1 g/in³, more preferably from 0.4 to 0.8 g/in³, more preferably from 0.45 to 0.7 g/in³, more preferably from 0.5 to 0.6 g/in³, more preferably from 0.53 to 0.55 g/in³.
56. The method of any of embodiments 31 to 55, wherein in steps (viii) and (ix) the one or more alkaline earth metals are coated onto the wall flow substrate in an amount in the range of from 0.01 to 2 g/in³ based on the volume of the catalyzed soot filter measured from the inlet end up to x % of the substrate axial length, preferably in an amount in the range of from 0.05 to 1 g/in³, more preferably from 0.1 to 0.8 g/in³, more preferably from 0.15 to 0.6 g/in³, more preferably from 0.2 to 0.45 g/in³, more preferably from 0.25 to 0.38 g/in³, more preferably from 0.28 to 0.35 g/in³, more preferably from 0.30 to 0.33 g/in³, more preferably from 0.31 to 0.32 g/in³.
57. The method of any of embodiments 31 to 56, wherein the particulate support material of step (ii) is selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is zirconia-alumina, wherein preferably the zirconia-alumina consists of alumina which is doped with zirconia, wherein more preferably alumina is doped with from 1 to 50 wt.-% of zirconia based on 100 wt.-% of zirconia-alumina, more preferably from 5 to 40 wt.-% of zirconia, more preferably from 10 to 30 wt.-% of zirconia, more preferably from 15 to 25 wt.-% of zirconia, and more preferably from 18 to 22 wt.-% of zirconia.
58. The method of any of embodiments 31 to 57, wherein the particulate support material of step (iv) is selected from the group consisting of alumina, silica, alumina-silica, titania, titania-alumina, zirconia, zirconia-alumina, baria-alumina, ceria, ceria-alumina, baria-ceria-alumina, magnesia, magnesia-alumina, magnesia-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, magnesia-alumina, magnesia-ceria-alumina, lanthana-alumina, lanthana-zirconia-alumina, and mixtures of two or more thereof, more preferably from the group consisting of alumina, alumina-silica, zirconia-alumina, ceria-alumina, magnesia-ceria-alumina, lanthana-alumina, lanthana-zirconia-alumina, and mixtures of two or more thereof, more preferably from the group consisting of alumina, zirconia-alumina, ceria-alumina, magnesia-ceria-alumina, and mixtures of two or more thereof, wherein more preferably the particulate support material is magnesia-ceria-alumina, wherein preferably the magnesia-ceria-alumina consists of alumina which is doped with magnesia and ceria, wherein more preferably alumina is doped with from 1 to 30 wt.-% of magnesia based on 100 wt.-% of magnesia-ceria-alumina, more preferably from 5 to 25 wt. % of magnesia, more preferably from 10 to 20 wt.-% of magnesia, more preferably from 12 to 18 wt.-% of magnesia, and more preferably from 14 to 16 wt.-% of magnesia, and independently thereof, with from 0.5 to 25 wt.-% of ceria based on 100 wt.-% of magnesia-ceria-alumina, more preferably from 1 to 20 wt.-% of ma ceria, more preferably from 5 to 15 wt. % of ceria, more preferably from 7 to 12 wt.-% of ceria, and more preferably from 9 to 11 wt.-% of ceria.
59. The method of any of embodiments 31 to 58, wherein independently from one another the average particle size D90 of the particulate support material of steps (ii) and (iv) is in the range of from 0.5 to 25 μm, more preferably of from 1 to 20 μm, more preferably of from 3 to 15 μm, more preferably of from 6 to 12 μm, and more preferably of from 8 to 10 μm.
60. The method of any of embodiments 31 to 59, wherein in steps (viii) and (ix) the particulate support material is coated onto the wall flow substrate in an amount in the range of from 0.05 to 5 Win′ based on the volume of the catalyzed soot filter measured from the inlet end up to x % of the substrate axial length, preferably from 0.1 to 3 g/in³, more preferably from 0.5 to 2.5 g/in³, more preferably from 1.0 to 2 g/in³, more preferably from 1.3 to 1.8 g/in³, more preferably from 1.4 to 1.6 g/in³, more preferably from 1.45 to 1.55 g/in³.
61. The method of any of embodiments 31 to 60, wherein in steps (x) and (xi) the SCR catalyst is coated onto the wall flow substrate in an amount in the range of from 0.05 to 6 g/in³ based on the volume of the catalyzed soot filter measured from the outlet end up to 100-x % of the substrate axial length, preferably from 0.1 to 5 g/in³, more preferably from 0.5 to 4 g/in³, more preferably from 0.8 to 3 g/in³, more preferably from 1 to 2.5 g/in³, more preferably from 1.3 to 2 g/in³, and more preferably from 1.5 to 1.9 g/in³.
62. A catalyzed soot filter, preferably according to any of embodiments 1 to 30, which is obtainable and/or obtained according to a method according to any of embodiments 31 to 61.
63. An emissions treatment system comprising a catalyzed soot filter (CSF) according to any of embodiments 1 to 30 or 62 and lean NOx trap (LNT) located upstream of the CSF, wherein the LNT and the CSF are in fluid communication with one another such that exhaust gas from an internal combustion engine may flow through the LNT and subsequently through the CSF,
   wherein the LNT comprises a flow through substrate comprising an inlet end, an outlet end, a substrate axial length extending between the inlet end and the outlet end, and a plurality of channels defined by internal walls of the wall flow substrate, and wherein the flow through substrate is coated with an LNT catalyst.
64. The emissions treatment system according to embodiment 63, wherein the LNT catalyst comprises one or more alkaline earth metals, preferably one or more alkaline earth metals selected from the group consisting of Mg, Ca, Ba, Sr, and combinations of two or more thereof, more preferably from the group consisting of Mg, Ca, Ba, and combinations of two or more thereof, wherein more preferably the LNT catalyst comprises Mg and/or Ba, preferably Ba, more preferably Mg and Ba.
65. The emissions treatment system according to embodiment 64, wherein the one or more alkaline earth metals are contained in the LNT catalyst in an amount in the range of from 0.05 to 2 g/in³ of the one or more alkaline earth metals calculated as the element and based on the total volume of the LNT, preferably in an amount in the range of from 0.1 to 1.5 g/in³, more preferably from 0.2 to 1 g/in³, more preferably from 0.25 to 0.7 g/in³, more preferably from 0.3 to 0.5 g/in³, more preferably from 0.35 to 0.45 g/in³, more preferably from 0.37 to 0.42 g/in³, and more preferably from 0.39 to 0.4 g/in³.
66. The emissions treatment system according to any of embodiments 63 to 65, wherein the LNT catalyst comprises one or more platinum group metals, preferably one or more platinum group metals selected from the group consisting of Pt, Pd, Rh, Ir, and combinations of two or more thereof, more preferably from the group consisting of Pt, Pd, Rh, and combinations of two or more thereof, wherein more preferably, the LNT catalyst comprises Pt, more preferably Pt and Pd, and more preferably Pt, Pd, and Rh.
67. The emissions treatment system according to embodiment 66, wherein the one or more platinum group metals are contained in the LNT catalyst in an amount in the range of from 10 to 400 g/ft³ of the one or more platinum group metals calculated as the element and based on the total volume of the LNT, preferably in an amount in the range of from 30 to 300 g/ft³, more preferably from 50 to 250 g/ft³, more preferably from 80 to 220 g/ft³, more preferably from 100 to 200 g/ft³, more preferably from 130 to 180 g/ft³, more preferably from 140 to 160 g/ft³, and more preferably from 145 to 155 g/ft³.
68. The emissions treatment system according to any of embodiments 63 to 67, wherein the LNT catalyst comprises platinum, wherein platinum is contained in the LNT catalyst in an amount in the range of from 5 to 400 g/ft³ of platinum calculated as the element and based on the total volume of the LNT, preferably in an amount in the range of from 10 to 300 g/ft³, more preferably from 30 to 250 g/ft³, more preferably from 50 to 200 g/ft³, more preferably from 80 to 180 g/ft³, more preferably from 100 to 150 g/ft³, more preferably from 120 to 130 g/ft³, and more preferably from 125 to 135 g/ft³.
69. The emissions treatment system according to any of embodiments 63 to 68, wherein the LNT catalyst comprises palladium, wherein palladium is contained in the LNT catalyst in an amount in the range of from 1 to 50 g/ft³ of palladium calculated as the element and based on the total volume of the LNT, preferably in an amount in the range of from 3 to 40 g/ft³, more preferably from 5 to 30 g/ft³, more preferably from 8 to 25 g/ft³, more preferably from 10 to 20 g/ft³, more preferably from 12 to 18 g/ft³, and more preferably from 14 to 16 g/ft³.
70. The emissions treatment system according to any of embodiments 63 to 69, wherein the LNT catalyst comprises rhodium, wherein rhodium is contained in the LNT catalyst in an amount in the range of from 0.1 to 20 g/ft³ of rhodium calculated as the element and based on the total volume of the LNT, preferably in an amount in the range of from 0.5 to 15 g/ft³, more preferably from 1 to 10 g/ft³, more preferably from 3 to 8 g/ft³, more preferably from 4 to 6 g/ft³, and more preferably from 4.5 to 5.5 g/ft³.
71. The emissions treatment system according to any of embodiments 64 to 70, wherein the one or more alkaline earth metals and/or, preferably and, the one or more platinum group metals contained in the LNT catalyst are supported on a particulate support material, wherein the particulate support material is preferably selected from the group consisting of alumina, silica, alumina-silica, titania, titania-alumina, zirconia, zirconia-alumina, baria-alumina, ceria, ceria-alumina, baria-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria, ceria-alumina, baria-ceria-alumina, lanthana-alumina, lanthana-zirconia-alumina, and mixtures of two or more thereof, more preferably from the group consisting of alumina, alumina-silica, zirconia-alumina, ceria, ceria-alumina, lanthana-alumina, lanthana-zirconia-alumina, and mixtures of two or more thereof, more preferably from the group consisting of alumina, ceria, ceria-alumina, and mixtures of two or more thereof, wherein more preferably the particulate support material is alumina and/or ceria, preferably γ-alumina.
72. The emissions treatment system according to embodiment 71, wherein the LNT catalyst comprises platinum and palladium, wherein platinum and palladium are supported on the same particles of the particulate support material, wherein preferably the particulate support material is selected from the group consisting of alumina, silica, alumina-silica, titania, titania-alumina, zirconia, zirconia-alumina, baria-alumina, ceria, ceria-alumina, baria-ceria-alumina, lanthana-alumina, lanthana-zirconia-alumina, titania-zirconia, and mixtures of two or more thereof, more preferably from the group consisting of alumina, alumina-silica, titania-alumina, zirconia-alumina, baria-alumina, ceria-alumina, baria-ceria-alumina, lanthana-alumina, lanthana-zirconia-alumina, and mixtures of two or more thereof, more preferably from the group consisting of alumina, alumina-silica, zirconia-alumina, lanthana-alumina, lanthana-zirconia-alumina, and mixtures of two or more thereof, wherein more preferably the particulate support material is alumina, preferably γ-alumina.
73. The emissions treatment system according to embodiment 71 or 72, wherein the LNT catalyst comprises rhodium, wherein rhodium is supported on a particulate support material selected from the group consisting of alumina, silica, alumina-silica, titania, titania-alumina, zirconia, zirconia-alumina, baria-alumina, ceria, ceria-alumina, baria-ceria-alumina, lanthana-alumina, lanthana-zirconia-alumina, titania-zirconia, and mixtures of two or more thereof, more preferably from the group consisting of alumina, alumina-silica, zirconia-alumina, ceria, ceria-alumina, lanthana-alumina, lanthana-zirconia-alumina, and mixtures of two or more thereof, wherein more preferably the particulate support material is ceria and/or ceria-alumina, preferably ceria.
74. The emissions treatment system according to any of embodiments 71 to 73, wherein the LNT catalyst comprises platinum, palladium, and rhodium, wherein rhodium is supported on separate particles of the particulate support material than palladium and platinum.
75. The emissions treatment system according to any of embodiments 71 to 74, wherein the average particle size D90 of the particulate support material is in the range of from 0.5 to 25 μm, more preferably of from 1 to 20 μm, more preferably of from 3 to 15 μm, more preferably of from 6 to 12 μm, and more preferably of from 8 to 10 μm.
76. The emissions treatment system according to any of embodiments 71 to 75, wherein the LNT catalyst comprises the particulate support material in an amount in the range of from 0.5 to 20 g/in³ based on the total volume of the LNT, preferably from 1 to 15 g/in³, more preferably from 2 to 10 g/in³, more preferably from 3 to 8 g/in³, more preferably from 3.5 to 6 g/in³, more preferably from 4 to 5.5 g/in³, more preferably from 4.3 to 5.2 g/in³, more preferably from 4.5 to 5 g/in³, more preferably from 4.7 to 4.9 g/in³, and more preferably from 4.75 to 4.85 g/in³.
77. The emissions treatment system according to any of embodiments 63 to 76, wherein the emissions treatment system further comprises a diesel oxidation catalyst (DOC) located upstream of the LNT, wherein the LNT is in fluid communication with the DOC such that exhaust gas from the combustion engine may flow through the DOC and subsequently through the LNT.
78. The emissions treatment system according to any of embodiments 63 to 77, wherein the emissions treatment system further comprises a means of injecting a source of ammonia and/or one or more hydrocarbons into the exhaust gas stream from the internal combustion engine, wherein said injection means is located downstream of the LNT and upstream of the CSF.
79. The emissions treatment system according to any of embodiments 63 to 78, wherein the emissions treatment system further comprises an internal combustion engine, wherein the internal combustion engine is preferably a diesel engine.
80. A process for the treatment of emissions from an internal combustion engine comprising directing exhaust gas from an internal combustion engine through an emissions treatment system as defined in any of embodiments 63 to 79.
81. Use of a catalyzed soot filter according to any of embodiments 1 to 30 or 62, or of an emissions treatment system according to any of embodiments 63 to 79 for the treatment of exhaust gas emissions, preferably for the simultaneous treatment of NON, hydrocarbons, and carbon monoxide in exhaust gas from an internal combustion engine, more preferably for the storage and conversion of NOx and/or for the selective catalytic reduction and/or for the oxidation of hydrocarbons and carbon monoxide of exhaust gas from an internal combustion engine, more preferably for the simultaneous storage and conversion of NOx, selective catalytic reduction of NOx, and oxidation of hydrocarbons and carbon monoxide in exhaust gas from an internal combustion engine, and more preferably for the selective catalytic reduction of exhaust gas from a diesel engine.

### EXPERIMENTAL SECTION

Throughout the examples and comparative examples in the following, unless indicated to the contrary, the values indicated in weight/volume and in particular in g/ft³ and g/in³ respectfully refer to the loading of the given element, compound, or material in the final catalyst based on the weight of the element or on the dry (calcined) weight of the compound or material per volume unit, wherein the volume refers to the volume of the monolith or honeycomb calculated based on its cross-sectional area and length. Accordingly, depending on the shape and dimensions of the monolith or honeycomb specifically employed for preparing the respective catalyst, the amounts of the element, compound or material and/or of their respective precursors are chosen such as to achieve the given loading as defined in the examples.

In instances wherein an element, compound, or material is provided only on a portion of the axial length of the monolith or honeycomb, unless otherwise specified, the loading refers to the weight on that axial portion of the monolith or honeycomb onto which the element, compound or material has been provided.

### Reference Example 1: Upstream LNT on Flow Through Substrate

To prepare the LNT, 1.41 g/in³ of 50%/50% ceria/alumina material was impregnated with an aqueous solution of barium acetate (0.29 g/in³ BaO). The resulting powder was calcined at 590° C. for 2 hours resulting in a Ba/Ceria material with 17 wt.-% BaO content. 1 g/in³ high porous γ-alumina was firstly impregnated with a platinum solution with platinum as an amine stabilized hydroxo Pt IV complex to give a dry content of Pt 130 g/ft³ and secondly with an aqueous solution of Palladium nitrate giving a final dry Pd content of 15 g/ft³. The resulting powder with a solid contend of 55-65% was dispersed in water.

For Rh impregnation, ceria (0.4 g/in³ CeO₂) was dispersed into water to a solid content of 43%. A solution of Rh nitrate was added to the ceria slurry giving a final dry Rh content of 5 g/ft³.

For the Ba impregnation on ceria (1.995 g/in³ CeO₂), ceria was impregnated with an aqueous solution of barium acetate (0.105 g/in³). The resulting powder was calcined at 590° C. for 2 hours resulting in a Ba/Ceria material with 5 wt.-% BaO content.

The resulting Rh/Ceria slurry, Ba/Ceria material (2.1 g/in³), Ba/Ce/Al material (1.7 g/in³), magnesium acetate tetrahydrate (0.3 g/in³ MgO) and zirconium acetate (0.05 g/in³ ZrO2) were added to the Pt/Pd/alumina slurry. The subsequent slurry was milled to a particle size d90 of 9 μm. The final slurry was subsequently coated onto a metallic flow through substrate. The coated substrate was dried at 110° C. air and calcined at 590° C. in air.

### Comparative Example 1: Wall Flow Filter with SCR Coated Inlet (100%)+Pd Coated Outlet (50%)

Copper Chabazite (CuCHA) was suspended in water to make a slurry with a solid content of 30-40%, after which this slurry was milled to D90=6 μm. Separately, a pre-milled Al₂O₃ powder doped with 5% SiO₂ (90% of the particles are less than 5 micrometers: D₉₀=5 μm) was suspended in water to reach 25% solid content. A palladium nitrate solution (20 wt.-% in H₂O) was added into the suspension drop-wise while stirring to afford a loading of 0.95 wt.-% of Pd on the alumina powder doped with 5 wt.-% silica.

A wall flow filter honeycomb substrate made of silicon carbide with a porosity of 63% with a mean pore size of 20 μm and a volume of 2.47 liter was provided. Firstly, the Pd slurry was coated from the outlet side of the filter. To this effect, the substrate was immersed into the slurry with outlet side down with the inlet side held above the slurry level to achieve 50% coverage of the filter substrate. The substrate was pulled out of the slurry, and a stream of air was blown from the inlet side of the channels until no washcoat slurry was coming out from the outlet side. The coated sample was then dried at 110° C. for 2 hours and calcined in air at 450° C. for 1 hour, resulting in 50% of the outlet side of the filter being coated with 5 g/ft³ (g/(30.48 cm)³) Pd on 0.15 g/in³ (g/(2.54 cm)³) Al₂O₃ powder doped with 5% SiO₂.

Finally, the Cu-CHA slurry was then coated from the inlet side along the entire length of the filter by immersing the substrate the entire length of the inlet side, with the outlet side held ¼ inch (2.54 cm) above the slurry level. After blowing off the excess slurry from the outlet side, the coated sample was then dried at 110° C. for 2 hours and calcined in air at 450° C. for 1 hour, resulting in the below indicated percentage of the inlet side of the filter being coated with 1.1 g/in³ (g/(2.54 cm)³) CuCHA.

### Comparative Example 3: Wall Flow Filter with LNT Coated Inlet (100%)

High porous alumina doped with 15 wt.-% MgO and 10 wt.-% ceria (dry content on substrate 0.85 g/ft³) was firstly impregnated with a platinum solution with platinum as an amine stabilized hydroxo Pt IV complex to give a dry Pt content of 50 g/ft³ and secondly with an aqueous solution of palladium nitrate giving a final dry Pd content of 5 g/ft³. The resulting powder with a solid content of 60-65% was dispersed in water.

For Rh impregnation high porous alumina doped with 20 wt.-% zirconia (0.2 g/in³) was impregnated with a solution of Rh nitrate (5 g/ft³ Rh calculated as the element). The resulting powder was calcined at 590° C. for 2 hours resulting in a Rh/Zr/alumina material with 5 g/ft³ Rh content.

The resulting Rh/Zr/alumina material, ceria (0.45 g/in³), Barium acetate (0.185 g/in³ BaO) and zirconium acetate (0.03 g/in³ ZrO2) were added to the Pt/Pd/Mg/Ce/Al alumina slurry. The subsequent slurry was milled to a particle size d90 of 9 μm.

A wall flow filter honeycomb substrate made of silicon carbide with a porosity of 63% with a mean pore size of 20 μm and a volume of 2.47 liter was provided.

The final slurry was then coated from the inlet side along the entire length of the filter by immersing the entire length of the substrate from the inlet side into the slurry. The outlet side was held ¼ inch (2.54 cm) above the slurry level. After blowing off the excess slurry from the outlet side, the coated sample was then dried at 110° C. for 2 hours and calcined in air at 450° C. for 1 hour, resulting in the below indicated percentage of the inlet side of the filter being coated with 1.7 g/in³ (g/(2.54 cm)³) LNT coating.

### Comparative Example 4: Wall Flow Filter with LNT Coated Inlet (50%)

An LNT slurry was prepared as described in Comparative Example 3.

A wall flow filter honeycomb substrate made of silicon carbide with a porosity of 63% with a mean pore size of 20 μm and a volume of 2.47 liter was provided.

The final slurry was coated from the inlet side along 50% of the length of the filter by immersing the substrate inlet side down into the slurry. The outlet side was held above the slurry level to achieve 50% coverage of the filter substrate. After blowing off the excess slurry from the outlet side, the coated sample was then dried at 110° C. for 2 hours and calcined in air at 450° C. for 1 hour, resulting in the below indicated percentage of the inlet side of the filter being coated with 1.7 g/in³ (g/(2.54 cm)³) LNT coating.

### Example 1: Wall Flow Filter with LNT Coated Inlet (50%)+SCR Coated Outlet (50%)

An LNT slurry was prepared as described in Comparative Example 3.

For the Preparation of the SCR slurry for the outlet coat, Copper Chabazite (CuCHA) was suspended in water to make a slurry with a solid content of 30-40%. This slurry was milled to D₉₀=6 μm.

A wall flow filter honeycomb substrate made of silicon carbide with a porosity of 63% with a mean pore size of 20 μm and a volume of 2.47 liter was provided.

Firstly the final LNT slurry was coated from the inlet side along 50% of the length of the filter by immersing the substrate inlet side down into the slurry. The outlet side was held above the slurry level to achieve 50% coverage of the filter substrate. After blowing off the excess slurry from the outlet side, the coated sample was then dried at 110° C. for 2 hours and calcined in air at 450° C. for 1 hour, resulting in the below indicated percentage of the inlet side of the filter being coated with 1.7 g/in³ (g/(2.54 cm)³) LNT coating.

Finally, the Cu-CHA slurry was then coated from the outlet side along 50% of the length of the filter by immersing the substrate outlet side down into the slurry. The inlet side was held above the slurry level to achieve 50% coverage of the filter substrate. After blowing off the excess slurry from the inlet side, the coated sample was then dried at 110° C. for 2 hours and calcined in air at 450° C. for 1 hour, resulting in the below indicated percentage of the inlet side of the filter being coated with 1.7 g/in³ (g/(2.54 cm)³) CuCHA.

TABLE 1
Overview of the catalyzed soot filter samples from Comparative Examples 1-4 and
from Example 1.

| | (coating length) | (coating length) outlet | total PGM loading [g/ft³] |
|---|---|---|---|
| Sample | inlet coat material | coat material | (Pt/Pd/Rh) |
| Comp. Example 1 | (100%) CuCHA | (100%) Pd-only | 2.5 (0/2.5/0) |
| Comp. Example 3 | (100%) LNT | — | 60 (50/5/5) |
| Comp. Example 4 | (50%) LNT | — | 30 (25/2.5/2.5) |
| Example 1 | (50%) LNT | (50%) CuCHA | 30 (25/2.5/2.5) |

### Example 2: World Light-Duty Harmonized (WLTC) Test Cycle—DeNOx, CO and HC Performance Evaluation

The coated filter substrates were evaluated as a passive SCR system with an upstream LNT for generating ammonia in situ prepared in accordance with Reference Example 1 on an engine test cell with standard WLTC procedure. The test cell was equipped with a Euro 6 2 L engine. The average temperature in the first 1000 s of the WLTC cycles was 240° C. Prior to testing, the samples were aged in an oven for 16 hours at 800° C. under air flow with 10% water vapor. A rich engine mode was applied during the WLTC at 7 different positions in the cycle at Lambda 0.95 in order to regenerate the LNT from stored NOx. The NOx, CO and HC conversions over the LNT and over the downstream coated filter substrate were measured, as well as the maximum ammonia emissions in the exhaust gas after having passed the catalyzed soot filter. The results are displayed in Table 2.

TABLE 2
Results from WLTC testing with respect to the conversion of
NOₓ, CO, and hydrocarbons (HC) and to NH₃

| | NOx | CO | HC | Maximum NH₃ |
|---|---|---|---|---|
| | Conversion | Conversion | Conversion | Emissions |
| Sample | [%] | [%] | [%] | [ppm] |
| Ref. Example 1 | 55 | 94 | 79 | — |
| Comp. Example 1 | 64 | 94 | 79 | 12 |
| Comp. Example 3 | 65 | 98 | 82 | 1180 |
| Comp. Example 4 | 62 | 97 | 80 | 1180 |
| Example 1 | 68 | 98 | 82 | 50 |

As may be taken from Table 2, the results obtained with the inventive catalyzed soot filter according to Example 1 constitute the best results in NOₓ conversion, and are only matched by Comparative Example 3 with respect to CO and HC conversion. The outstanding results with respect to CO and HC conversion are highly unexpected in view of the fact that the inventive catalyzed soot filter according to Example 1 only contains half(!) the loading in platinum group metals compared to Comparative Example 3. Accordingly, as demonstrated by these results, it has quite surprisingly been found that a catalyzed soot filter may be provided by the present invention which not only affords a high conversion of NON, in particular under passive SCR testing conditions employing an LNT located upstream of the catalyzed soot filter, but quite unexpectedly also allows for a high conversion of both CO and hydrocarbons despite that fact that only a reduced loading of platinum group metals is present thereon. All the more surprisingly, the ammonia slip in the inventive catalyst sample of Example 1 is extremely low even when compared to Comparative Examples 1, despite the fact that it only half the amount of SCR catalyst is contained therein. Finally, analysis of H₂S emissions in selected samples has revealed that compared to Comparative Example 3 which displays high H₂S levels in the exhaust gas, the sample of inventive Example 1 is able to effectively reduce H₂S emissions.

Consequently, in view of the results discussed above, the specific design of a catalyzed soot filter as defined in the present application affords a highly efficient catalyzed soot filter not only with respect to the conversion of the main exhaust gas pollutants which are NO_{N}, COₓ, and hydrocarbons, but furthermore with respect to excess ammonia contained in the exhaust gas after treatment thereof as well as with respect to the treatment of H₂S therein. The inventive catalyst as defined in the present application therefore surprisingly displays an unexpectedly high proficiency in the treatment of exhaust gas not only with respect to the components contained therein, but also with respect to ammonia generated in situ during the treatment process and which may effectively be prevented from slipping into the environment.

1: A catalyzed soot filter (CSF), comprising:
a porous wall flow substrate;
a lean NOx trap (LNT) catalyst; and
a catalyst for selective catalytic reduction (SCR),
wherein:
the porous wall flow substrate comprises an inlet end, an outlet end, a substrate axial length extending between the inlet end and the outlet end, and a plurality of channels defined by internal walls of the porous wall flow substrate;
the plurality of channels comprise inlet channels having an open inlet end and a closed outlet end, and outlet channels having a closed inlet end and an open outlet end;
the LNT catalyst is provided on a portion of the surface of the inlet channel walls and on at least a portion of the surface of pores within the channel walls underneath the surface of the channel walls coated with the LNT catalyst;
the portion of the inlet channel walls coated with the LNT catalyst extends from the inlet end to x % of the substrate axial length with: 0<x<100;
the SCR catalyst is provided on a portion of the surface of the outlet channel walls and on at least a portion of the surface of the pores within the channel walls underneath the surface of the channel walls coated with the SCR catalyst; and
the portion of the outlet channel walls coated with the SCR catalyst extends from the outlet end to 100-x % of the substrate axial length.

2: The catalyzed soot filter of claim 1, wherein x ranges from 5 to 95.

3: The catalyzed soot filter of claim 1, wherein the porous wall flow substrate is a honeycomb substrate with alternately plugged inlet and outlet ends such that each wall of the wall flow substrate respectively has a first surface which is a surface of an inlet channel and a second surface which is a surface of an outlet channel.

4: The catalyzed soot filter of claim 1, wherein the SCR catalyst comprises one or more zeolites.

5: The catalyzed soot filter of claim 4, wherein the one or more zeolites comprise one or more transition metals.

6: The catalyzed soot filter of claim 1, wherein the average particle size D90 of the SCR catalyst is 25% or less of the average pore size of the walls of the substrate.

7: The catalyzed soot filter of claim 1, wherein the LNT catalyst comprises one or more alkaline earth metals.

8: The catalyzed soot filter of claim 1, wherein the LNT catalyst comprises one or more platinum group metals.

9: The catalyzed soot filter of claim 1, wherein the LNT catalyst comprises one or more oxygen storage components.

10: A method of preparing a catalyzed soot filter, the method comprising:
(i) providing a porous wall flow substrate comprising an inlet end, an outlet end, a substrate axial length extending between the inlet end and the outlet end, and a plurality of channels defined by internal walls of the wall flow substrate, wherein the plurality of channels comprise inlet channels having an open inlet end and a closed outlet end, and outlet channels having a closed inlet end and an open outlet end;
(ii) impregnating a particulate support material with an aqueous solution of a rhodium compound;
(iii) calcining the impregnated particulate support material obtained in (ii) for providing a supported Rh powder;
(iv) mixing a particulate support material with distilled water and subsequently adding an aqueous solution of a palladium compound and of a platinum compound thereto for providing a first slurry;
(v) adding the supported Rh powder, one or more oxygen storage materials, and one or more alkaline earth metal compounds to the first slurry obtained in (iv) for providing a second slurry;
(vi) optionally milling the second slurry, wherein said second slurry displays an average particle size D90 which is 25% or less of the average pore size of the walls of the porous wall flow substrate;
(vii) suspending a solid SCR catalyst in distilled water and optionally milling the resulting mixture for providing a third slurry, wherein said third slurry displays an average particle size D90 which is 25% or less of the average pore size of the walls of the porous wall flow substrate;
(viii) coating a portion of the inlet channel walls of the wall flow substrate by immersing the inlet end of the wall flow substrate into the second slurry up to x % of the substrate axial length extending from the inlet end with: 0<x<100;
(ix) removing the wall flow substrate from the second slurry and removing excess slurry from the inlet channels;
(x) coating a portion of the outlet channel walls of the wall flow substrate by immersing the outlet end of the wall flow substrate into the third slurry up to 100-x % of the substrate axial length extending from the outlet end;
(xi) removing the wall flow substrate from the third slurry and removing excess slurry from the outlet channels; and
(xii) optionally drying, calcining, or both, the coated wall flow substrate.

11: A catalyzed soot filter obtained by the method of claim 10.

12: An emissions treatment system, comprising
the catalyzed soot filter (CSF) of claim 1; and
a lean NOx trap (LNT) located upstream of the CSF,
wherein:
the LNT and the CSF are in fluid communication with one another such that exhaust gas from an internal combustion engine may flow through the LNT and subsequently through the CSF;
the LNT comprises a flow through substrate comprising an inlet end, an outlet end, a substrate axial length extending between the inlet end and the outlet end, and a plurality of channels defined by internal walls of the wall flow substrate; and
the flow through substrate is coated with the LNT catalyst.

13: The emissions treatment system according to claim 12, wherein the LNT catalyst comprises one or more alkaline earth metals.

14: The emissions treatment system according to claim 12, wherein the LNT catalyst comprises one or more platinum group metals.

15: A process for treating emissions from an internal combustion engine, the process comprising directing exhaust gas from an internal combustion engine through the emissions treatment system of claim 12.

16: A process for treating exhaust gas emissions, the process comprising contacting exhaust gas from an internal combustion with the catalyzed soot filter of claim 1.
